(19) United States
(12) Patent Application Publication
(10) Pub. No.: US 2008/0174285 A1
(43) Pub. Date: Jul. 24, 2008

(54) Common electrode voltage generation circuit, display driver and electronic instrument

(75) Inventor: Akira Morita, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 12/010,059

(22) Filed: Jan. 18, 2008

(30) Foreign Application Priority Data
Jan. 22, 2007 (JP) 2007-011221
Dec. 19, 2007 (JP) 2007-327192

(51) Int. Cl. G05F 1/40; G06F 3/038

(52) U.S. Cl. 323/268; 345/204

(57) ABSTRACT

A common electrode voltage generation circuit that supplies a high-potential-side voltage or a low-potential-side voltage to a common electrode opposite to a pixel electrode through an electro-optical substance. The common electrode voltage generation circuit includes a first high-potential-side voltage generation circuit that outputs a first high-potential-side voltage, an output of the first high-potential-side voltage generation circuit being connected to one end of a first high-potential-side stabilization capacitor element, and a second high-potential-side voltage generation circuit that outputs a second high-potential-side voltage, an output of the second high-potential-side voltage generation circuit being connected to one end of a second high-potential-side stabilization capacitor element. When supplying the high-potential-side voltage to the common electrode, the common electrode voltage generation circuit electrically connects the output of the first high-potential-side voltage generation circuit to the common electrode, and then electrically connects the output of the second high-potential-side voltage generation circuit to the common electrode.

Japanese Patent Application No. 2007-011221 filed on Jan. 22, 2007 and Japanese Patent Application No. 2007-327192 filed on Dec. 19, 2007, are hereby incorporated by reference in their entirety.

### BACKGROUND OF THE INVENTION

The present invention relates to a common electrode voltage generation circuit, a power supply circuit, a display driver, an electro-optical device, an electronic instrument, and the like.

An active matrix type liquid crystal display device includes a plurality of gate lines and a plurality of source lines formed in a matrix. The active matrix type liquid crystal display device also includes a plurality of switching elements, each of which is connected to the corresponding gate line and the corresponding source line, and a plurality of pixel electrodes, each of which is connected to the corresponding switching element. The pixel electrodes are opposite to a common electrode through a liquid crystal (electro-optical substance in a broad sense).

In the liquid crystal display device having such a configuration, a voltage supplied to the source line is applied to the pixel electrode via the switching element which has been turned ON through the selected gate line. The transmissivity of the pixel changes depending on the voltage applied between the pixel electrode and the common electrode.

In a liquid crystal display device, a liquid crystal must be AC-driven in order to prevent deterioration in the liquid crystal. Therefore, polarity inversion drive is performed in the liquid crystal display device in which the polarity of the voltage applied between the pixel electrode and the common electrode is reversed upon expiration of one frame or one or more horizontal scan periods. For example, polarity inversion drive is implemented by changing the voltage supplied to the common electrode in synchronization with the polarity inversion timing.

JP-A-2005-37834 discloses a method which controls the common electrode when performing polarity inversion drive, for example. According to the technology disclosed in JP-A-2005-37834, polarity inversion drive is implemented by changing the voltage applied to the common electrode. Specifically, JP-A-2005-37834 discloses technology which quickly charges or discharges the common electrode by supplying an intermediate voltage to the common electrode and then supplying a desired voltage to the common electrode when changing the voltage applied to the common electrode.

A circuit which generates a common electrode voltage applied to the common electrode generates a high-potential-side voltage and a low-potential-side voltage, and alternately outputs the high-potential-side voltage and the low-potential-side voltage in synchronization with the polarity inversion timing. Therefore, the high-potential-side voltage and the low-potential-side voltage are stored in stabilization capacitor elements provided inside or outside of the circuit. It is desirable that the stabilization capacitor element have a large capacitance taking into account the stability of the potentials of the high-potential-side voltage and the low-potential-side voltage.

On the other hand, when changing the common electrode voltage, a charge is redistributed between the stabilization capacitor element and a parasitic capacitor (load capacitor) of the common electrode. This causes a change in the potential of the common electrode. For example, when the amplitude of the common electrode voltage is 5 V, the load capacitance of the common electrode is 11 nanofarads (nF), and the capacitance of the stabilization capacitor element is 2.2 microfarads (microF), the capacitance of the stabilization capacitor element is 200 times the load capacitance of the common electrode. Therefore, the potential of the common electrode changes in an amount of about 25 mV (=5/200). In recent years, an increase in grayscale level has been desired, for example. A change in potential in an amount of 25 mV corresponds to a change by five grayscale levels when the grayscale level is indicated by eight bits. A change in voltage by five grayscale levels is easily observed with the naked eye.

A change in voltage applied to the common electrode can be absorbed by increasing the current drive capability of an operational amplifier which drives the common electrode. On the other hand, it is necessary to increase the operating current of the operational amplifier in order to increase its current drive capability. When the load capacitance of the common electrode increases due to an increase in the screen size of the liquid crystal display device, the operating current of the operational amplifier must be increased to a large extent.

### SUMMARY

According to one aspect of the invention, there is provided a common electrode voltage generation circuit that supplies a high-potential-side voltage or a low-potential-side voltage to a common electrode opposite to a pixel electrode through an electro-optical substance, the common electrode voltage generation circuit comprising:

a first high-potential-side voltage generation circuit that outputs a first high-potential-side voltage, an output of the first high-potential-side voltage generation circuit being connected to one end of a first high-potential-side stabilization capacitor element; and

a second high-potential-side voltage generation circuit that outputs a second high-potential-side voltage, an output of the second high-potential-side voltage generation circuit being connected to one end of a second high-potential-side stabilization capacitor element,

when supplying the high-potential-side voltage to the common electrode, the common electrode voltage generation circuit electrically connecting the output of the first high-potential-side voltage generation circuit to the common electrode, and then electrically connecting the output of the second high-potential-side voltage generation circuit to the common electrode.

According to another aspect of the invention, there is provided a common electrode voltage generation circuit that supplies a high-potential-side voltage or a low-potential-side voltage to a common electrode opposite to a pixel electrode through an electro-optical substance, the common electrode voltage generation circuit comprising:

a first low-potential-side voltage generation circuit that outputs a first low-potential-side voltage, an output of the first low-potential-side voltage generation circuit being connected to one end of a first low-potential-side stabilization capacitor element; and

a second low-potential-side voltage generation circuit that outputs a second low-potential-side voltage, an output of the second low-potential-side voltage generation circuit being connected to one end of a second low-potential-side stabilization capacitor element,

when supplying the low-potential-side voltage to the common electrode, the common electrode voltage generation circuit electrically connecting the output of the first low-potential-side voltage generation circuit to the common electrode, and then electrically connecting the output of the second low-potential-side voltage generation circuit to the common electrode.

According to another aspect of the invention, there is provided a display driver that drives a source line of an electro-optical device, the display driver comprising:

a source driver that drives the source line; and

one of the above common electrode voltage generation circuits that supplies the common electrode voltage to a common electrode of the electro-optical device, the common electrode being opposite to a pixel electrode through an electro-optical substance.

According to another aspect of the invention, there is provided an electronic instrument comprising the above common electrode voltage generation circuit.

### BRIEF DESCRIPTION OF THE SEVERAL VIEWS OF THE DRAWING

FIG. 1 is a view showing an outline of the configuration of a liquid crystal display device according to one embodiment of the invention.

FIG. 2 is a view showing another configuration example of a liquid crystal display device according to one embodiment of the invention.

FIG. 3 is a block diagram showing a configuration example of a gate driver shown in FIG. 1 or 2.

FIG. 4 is a block diagram showing a configuration example of a source driver shown in FIG. 1 or 2.

FIG. 5 is a view illustrative of the operation of a multiplexer circuit shown in FIG. 4.

FIG. 6 is a view showing a configuration example of a reference voltage generation circuit, a DAC, and a source line driver circuit shown in FIG. 4.

FIG. 7 is a view illustrative of the operation of a demultiplexer shown in FIG. 1 or 2.

FIG. 8 is a block diagram showing a configuration example of a power supply circuit shown in FIG. 1 or 2.

FIG. 9 is a view showing an example of a drive waveform of a display panel shown in FIG. 1 or 2.

FIG. 10 is a view illustrative of polarity inversion drive according to one embodiment of the invention.

FIG. 11 is a block diagram showing a configuration example of a common electrode voltage generation circuit according to a comparative example of one embodiment of the invention.

FIG. 12 is a simulation waveform diagram showing an operation example of the common electrode voltage generation circuit shown in FIG. 11.

FIG. 13 is a block diagram showing a common electrode voltage generation circuit according to a first configuration example of one embodiment of the invention.

FIG. 14 is a timing diagram showing a control example of the common electrode voltage generation circuit shown in FIG. 13.

FIG. 15 is a simulation waveform diagram showing an operation example of the common electrode voltage generation circuit according to the first configuration example.

FIG. 16 is a block diagram showing a common electrode voltage generation circuit according to a second configuration example of one embodiment of the invention.

FIG. 17 is a simulation waveform diagram showing an operation example of the common electrode voltage generation circuit according to the second configuration example.

FIG. 18 is a block diagram showing a common electrode voltage generation circuit according to a third configuration example of one embodiment of the invention.

FIG. 19 is a simulation waveform diagram showing an operation example of the common electrode voltage generation circuit according to the third configuration example.

FIG. 20 is a block diagram showing a common electrode voltage generation circuit according to a fourth configuration example of one embodiment of the invention.

FIG. 21 is a simulation waveform diagram showing an operation example of the common electrode voltage generation circuit according to the fourth configuration example.

FIG. 22 is a view schematically showing another configuration of a liquid crystal display device according to one embodiment of the invention.

FIG. 23 is a block diagram showing another configuration example of the liquid crystal display device shown in FIG. 22.

FIG. 24 is a block diagram showing a configuration example of a source driver shown in FIG. 22 or 23.

FIG. 25 is a block diagram showing another configuration example of a source driver according to one embodiment of the invention.

FIG. 26 is a timing diagram showing a control example of the common electrode voltage generation circuit shown in FIG. 13 when a source driver performs normal drive.

FIG. 27 is a block diagram showing a configuration example of a projection-type display device to which a liquid crystal device according to one embodiment of the invention is applied.

FIG. 28 is a schematic view showing the main portion of a projection-type display device.

FIG. 29 is a block diagram showing a configuration example of a portable telephone to which a liquid crystal display device according to one embodiment of the invention is applied.

### DETAILED DESCRIPTION OF THE EMBODIMENT

Some aspects of the invention may provide a common electrode voltage generation circuit, a power supply circuit, a display driver, an electro-optical device, and an electronic instrument which can suppress a change in voltage of a common electrode while suppressing an increase in power consumption even if the load capacitance of the common electrode increases.

According to one embodiment of the invention, there is provided a common electrode voltage generation circuit that supplies a high-potential-side voltage or a low-potential-side voltage to a common electrode opposite to a pixel electrode through an electro-optical substance, the common electrode voltage generation circuit comprising:

a first high-potential-side voltage generation circuit that outputs a first high-potential-side voltage, an output of the first high-potential-side voltage generation circuit being connected to one end of a first high-potential-side stabilization capacitor element; and

a second high-potential-side voltage generation circuit that outputs a second high-potential-side voltage, an output of the second high-potential-side voltage generation circuit being connected to one end of a second high-potential-side stabilization capacitor element,

when supplying the high-potential-side voltage to the common electrode, the common electrode voltage generation circuit electrically connecting the output of the first high-potential-side voltage generation circuit to the common electrode, and then electrically connecting the output of the second high-potential-side voltage generation circuit to the common electrode.

In the common electrode voltage generation circuit according to this embodiment,

the first high-potential-side voltage generation circuit may output a divided voltage as the first high-potential-side voltage, the divided voltage being obtained by dividing a voltage between a given high-potential-side power supply and the output of the second high-potential-side voltage generation circuit using resistors.

In the common electrode voltage generation circuit according to this embodiment,

the first high-potential-side voltage generation circuit may output a divided voltage as the first high-potential-side voltage, the divided voltage being obtained by dividing a voltage between a given high-potential-side power supply and a given low-potential-side power supply using resistors.

In the common electrode voltage generation circuit according to this embodiment,

the first high-potential-side voltage generation circuit may output a voltage pulled up to a given high-potential-side power supply as the first high-potential-side voltage.

According to this embodiment, when the high-potential-side voltage is supplied to the common electrode, a charge is redistributed between the common electrode and the first high-potential-side stabilization capacitor element. Therefore, a change in the potential of the common electrode is absorbed by the first high-potential-side stabilization capacitor element. Since the second high-potential-side voltage is then supplied to the common electrode due to a charge stored in the second high-potential-side stabilization capacitor element, a change in the potential of the high-potential-side voltage of the common electrode can be reduced.

In the common electrode voltage generation circuit according to this embodiment,

the second high-potential-side voltage generation circuit may include an operational amplifier, a given reference high-potential-side voltage being input to the operational amplifier; and

the given high-potential-side power supply may be a high-potential-side power supply of the operational amplifier.

According to this embodiment, the high-potential-side power supply can be applied by a simple configuration.

In the common electrode voltage generation circuit according to this embodiment,

the first high-potential-side voltage may be higher in potential than the second high-potential-side voltage.

According to the invention, a decrease in the voltage of the common electrode can be reduced, whereby the voltage of the common electrode can be quickly stabilized at the potential level of the high-potential-side voltage when supplying the high-potential-side voltage as the common electrode voltage.

In the common electrode voltage generation circuit according to this embodiment,

a period when the output of the first high-potential-side voltage generation circuit is electrically connected to the common electrode may be shorter than a period when the output of the second high-potential-side voltage generation circuit is electrically connected to the common electrode.

According to this embodiment, a change in the potential level of the high-potential-side voltage of the common electrode can be reduced as the period in which the output of the second high-potential-side voltage generation circuit is electrically connected to the common electrode increases.

In the common electrode voltage generation circuit according to this embodiment,

when performing multiplex drive that writes a corresponding grayscale voltage among a plurality of grayscale voltages into the pixel electrode in each of a plurality of periods, the corresponding grayscale voltage corresponding to one period among the plurality of periods, the plurality of periods being specified by dividing one horizontal scan period, the common electrode voltage generation circuit may electrically connect the output of the first high-potential-side voltage generation circuit to the common electrode and then may electrically connect the output of the second high-potential-side voltage generation circuit to the common electrode in each of the plurality of periods when supplying the high-potential-side voltage to the common electrode.

According to this embodiment, a change in the voltage level of the common electrode during multiplex drive can be suppressed, whereby deterioration in image quality can be prevented even when performing multiplex drive.

In the common electrode voltage generation circuit according to this embodiment,

the common electrode voltage generation circuit may further include:

a first high-potential-side terminal that is connected to the one end of the first high-potential-side stabilization capacitor element; and

a second high-potential-side terminal that is connected to the one end of the second high-potential-side stabilization capacitor element.

According to another embodiment of the invention, there is provided a common electrode voltage generation circuit that supplies a high-potential-side voltage or a low-potential-side voltage to a common electrode opposite to a pixel electrode through an electro-optical substance, the common electrode voltage generation circuit comprising:

a first low-potential-side voltage generation circuit that outputs a first low-potential-side voltage, an output of the first low-potential-side voltage generation circuit being connected to one end of a first low-potential-side stabilization capacitor element; and

a second low-potential-side voltage generation circuit that outputs a second low-potential-side voltage, an output of the second low-potential-side voltage generation circuit being connected to one end of a second low-potential-side stabilization capacitor element,

when supplying the low-potential-side voltage to the common electrode, the common electrode voltage generation circuit electrically connecting the output of the first low-potential-side voltage generation circuit to the common electrode, and then electrically connecting the output of the second low-potential-side voltage generation circuit to the common electrode.

In the common electrode voltage generation circuit according to this embodiment,

the first low-potential-side voltage generation circuit may output a divided voltage as the first low-potential-side voltage, the divided voltage being obtained by dividing a voltage between a given low-potential-side power supply and the output of the second low-potential-side voltage generation circuit using resistors.

In the common electrode voltage generation circuit according to this embodiment,

the first low-potential-side voltage generation circuit may output a divided voltage as the first low-potential-side voltage, the divided voltage being obtained by dividing a voltage between a given low-potential-side power supply and a ground power supply using resistors.

In the common electrode voltage generation circuit according to this embodiment,

the first low-potential-side voltage generation circuit may output a voltage pulled down to a given low-potential-side power supply as the first low-potential-side voltage.

According to this embodiment, when the low-potential-side voltage is supplied to the common electrode, a charge is redistributed between the common electrode and the first low-potential-side stabilization capacitor element. Therefore, a change in the potential of the common electrode is absorbed by the first low-potential-side stabilization capacitor element. Since the second low-potential-side voltage is then supplied to the common electrode due to a charge stored in the second low-potential-side stabilization capacitor element, a change in the potential of the low-potential-side voltage of the common electrode can be reduced.

In the common electrode voltage generation circuit according to this embodiment,

the second low-potential-side voltage generation circuit may include an operational amplifier, a given reference low-potential-side voltage being input to the operational amplifier; and

the given low-potential-side power supply may be a low-potential-side power supply of the operational amplifier.

According to this embodiment, the low-potential-side power supply can be applied by a simple configuration.

In the common electrode voltage generation circuit according to this embodiment,

the first low-potential-side voltage may be lower in potential than the second low-potential-side voltage.

According to the invention, an increase in the voltage of the common electrode can be reduced, whereby the voltage of the common electrode can be quickly stabilized at the potential level of the low-potential-side voltage when supplying the low-potential-side voltage as the common electrode voltage.

In the common electrode voltage generation circuit according to this embodiment,

a period when the output of the first low-potential-side voltage generation circuit is electrically connected to the common electrode may be shorter than a period when the output of the second low-potential-side voltage generation circuit is electrically connected to the common electrode.

According to this embodiment, a change in the potential level of the low-potential-side voltage of the common electrode can be reduced as the period in which the output of the second low-potential-side voltage generation circuit is electrically connected to the common electrode increases.

In the common electrode voltage generation circuit according to this embodiment,

when performing multiplex drive that writes a corresponding grayscale voltage among a plurality of grayscale voltages into the pixel electrode in each of a plurality of periods, the corresponding grayscale voltage corresponding to one period among the plurality of periods, the plurality of periods being specified by dividing one horizontal scan period, the common electrode voltage generation circuit may electrically connect the output of the first low-potential-side voltage generation circuit to the common electrode and then may electrically connect the output of the second low-potential-side voltage generation circuit to the common electrode in each of the plurality of periods when supplying the low-potential-side voltage to the common electrode.

According to this embodiment, a change in the voltage level of the common electrode during multiplex drive can be suppressed, whereby deterioration in image quality can be prevented even when performing multiplex drive.

In the common electrode voltage generation circuit according to this embodiment,

the common electrode voltage generation circuit may further include:

a first low-potential-side terminal that is connected to the one end of the first low-potential-side stabilization capacitor element; and

a second low-potential-side terminal that is connected to the one end of the second low-potential-side stabilization capacitor element.

According to another embodiment of the invention, there is provided a power supply circuit that generates a power supply to drive a source line or a gate line of an electro-optical device, the power supply circuit comprising:

one of the above common electrode voltage generation circuits.

According to this embodiment, a power supply circuit can be provided which can suppress a change in the voltage of the common electrode while suppressing an increase in power consumption even if the load capacitance of the common electrode increase.

According to another embodiment of the invention, there is provided a display driver that drives a source line of an electro-optical device, the display driver comprising:

a source driver that drives the source line; and

the above common electrode voltage generation circuits that supplies the common electrode voltage to a common electrode of the electro-optical device, the common electrode being opposite to a pixel electrode through an electro-optical substance.

According to this embodiment, a display driver can be provided which can suppress a change in the voltage of the common electrode while suppressing an increase in power consumption even if the load capacitance of the common electrode increases.

Another embodiment of the invention relates to an electro-optical device comprising: a plurality of source lines; a plurality of gate lines; a plurality of pixel electrodes, each of the plurality of pixel electrodes being specified by a source line among the plurality of source lines and a gate line among the plurality of gate lines; a common electrode that is opposite to the plurality of pixel electrodes through an electro-optical substance; and the above common electrode voltage generation circuit that supplies the common electrode voltage to the common electrode.

According to this embodiment, an electro-optical device can be provided which can suppress a change in the voltage of the common electrode while suppressing an increase in power consumption even if the load capacitance of the common electrode increases.

Another embodiment of the invention relates to an electronic instrument comprising the above common electrode voltage generation circuit.

Another embodiment of the invention relates to an electronic instrument comprising the above power supply circuit.

Another embodiment of the invention relates to an electronic instrument comprising the above display driver.

A further embodiment of the invention relates to an electronic instrument comprising the above electro-optical device.

According to the above embodiment, an electronic instrument can be provided which can suppress a change in the voltage of the common electrode while suppressing an increase in power consumption even if the load capacitance of the common electrode increases.

Embodiments of the invention are described in detail below with reference to the drawings. Note that the embodiments described below do not in any way limit the scope of the invention laid out in the claims. Note that all elements of the embodiments described below should not necessarily be taken as essential requirements for the invention.

1. Liquid Crystal Display Device

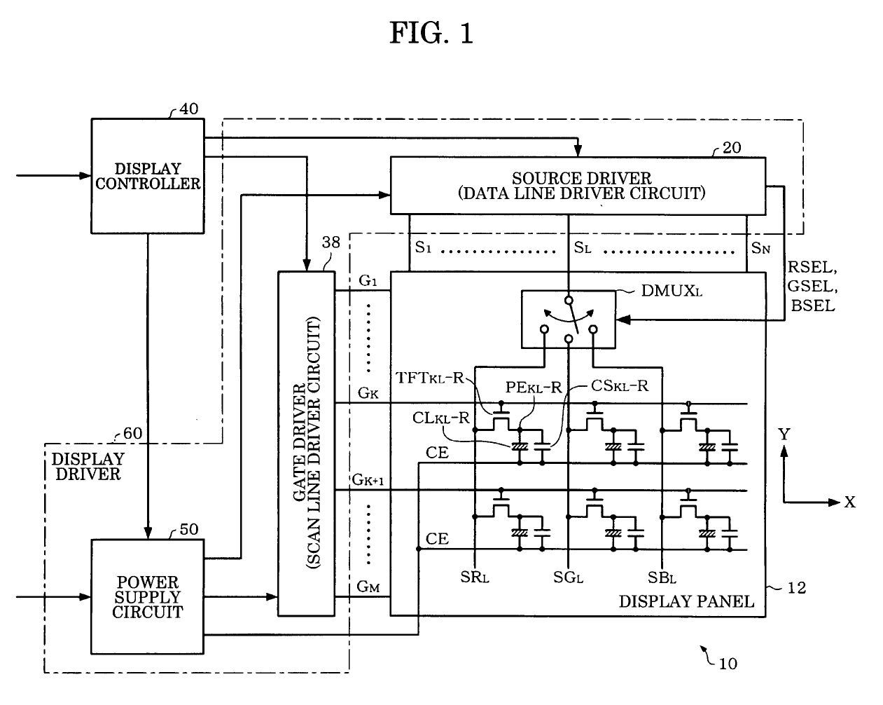

FIG. 1 shows an outline of the configuration of a liquid crystal display device according to one embodiment of the invention.

A liquid crystal display device 10 (liquid crystal device; electro-optical device in a broad sense) includes a display panel 12 (liquid crystal panel or liquid crystal display (LCD) panel in a narrow sense; electro-optical panel in a broad sense), a source driver 20 (data line driver circuit in a broad sense), a gate driver 38 (scan line driver circuit in a broad sense), a display controller 40, and a power supply circuit 50. Note that the liquid crystal display device 10 need not necessarily include all of these circuit blocks. The liquid crystal display device 10 may have a configuration in which some of these circuit blocks are omitted. The term “electro-optical device” may include a device using a light-emitting element such as an organic electroluminescence (EL) element or an inorganic EL element.

The display panel 12 (electro-optical device) includes a plurality of gate lines (scan lines in a broad sense), a plurality of source lines (data lines in a broad sense), and pixel electrodes specified by the gate lines and the source lines. In this case, an active matrix type liquid crystal device may be formed by connecting a thin film transistor (TFT; switching element in a broad sense) to the source line and connecting the pixel electrode to the TFT.

Specifically, the display panel 12 is a liquid crystal panel formed on an active matrix substrate (e.g., glass substrate). Gate lines G₁ to G_{M} (M is a natural number equal to or larger than two), arranged in a direction Y in FIG. 1 and extending in a direction X, and source lines SR₁, SG₁, SB₁, SR₂, SG₂, SB₂, . . . , SR_{N}, SG_{N}, and SB_{N} (N is a natural number equal to or larger than two), arranged in the direction X and extending in the direction Y, are disposed on the active matrix substrate. Source voltage supply lines S₁ to S_{N} are provided on the active matrix substrate. Demultiplexers are also provided on the active matrix substrate corresponding to the source voltage supply lines.

A thin film transistor TFT_{KL}-R (thin film transistor TFT_{KL}-G or TFT_{KL}-B) (switching element in a broad sense) is provided at a position corresponding to the intersection of the gate line G_{K} (1≦K≦M, K is a natural number) and the source line SR_{L} (source line SG_{L} or SB_{L}) (1≦L≦N, L is a natural number).

For example, a gate electrode of the thin film transistor TFT_{KL}-R is connected to the gate line G_{K}, a source electrode of the thin film transistor TFT_{KL}-R is connected to the source line SRI, and a drain electrode of the thin film transistor TFT_{KL}-R is connected to a pixel electrode PE_{KL}-R. A liquid crystal capacitor CL_{KL}-R (liquid crystal element) (element capacitor) and an auxiliary capacitor CS_{KL}-R are formed between the pixel electrode PE_{KL}-R and a common electrode CE opposite to the pixel electrode PE_{KL}-R through a liquid crystal (electro-optical substance in a broad sense). The liquid crystal is sealed between the active matrix substrate provided with the thin film transistor TFT_{KL}-R, the pixel electrode PE_{KL}-R, and the like and a common substrate provided with the common electrode CE. The transmissivity of the pixel changes depending on the voltage applied between the pixel electrode PE_{KL}-R and the common electrode CE. The term “element capacitor” may include a liquid crystal capacitor formed in a liquid crystal element and a capacitor formed in an EL element such as an inorganic EL element.

A demultiplexer DMUX_{L} separately supplies grayscale voltages supplied to the source voltage supply line S_{L} by time division to the source lines SR_{L}, SG_{L}, and SB_{L}. The demultiplexer DMUX_{L} separately supplies the grayscale voltages supplied to the source voltage supply line S_{L} to the source lines based on a multiplex control signal supplied from the source driver 20.

The voltage level of a common electrode voltage VCOM (high-potential-side voltage VCOMH or low-potential-side voltage VCOML) applied to the common electrode CE is generated by a common electrode voltage generation circuit included in the power supply circuit 50. The common electrode CE is formed over the entire common substrate, for example.

The source driver 20 drives the source voltage supply lines S₁ to S_{N} of the display panel 12 based on grayscale data. Since the demultiplexers DMUX₁ to DMUX_{N} separate the grayscale voltages when the source driver 20 drives the source voltage supply lines S₁ to S_{N}, the source driver 20 can drive the source lines SR₁, SG₁, SB₁, SR₂, SG₂, SB₂, . . . , SR_{N}, SG_{N}, and SB_{N}. The gate driver 38 scans (sequentially drives) the gate lines G₁ to G_{M} of the display panel 12.

The display controller 40 controls the source driver 20, the gate driver 38, and the power supply circuit 50 based on information set by a host (not shown) such as a central processing unit (CPU). Specifically, the display controller 40 sets the operation mode of the source driver 20 and the gate driver 38 or supplies a vertical synchronization signal and a horizontal synchronization signal generated therein to the source driver 20 and the gate driver 38, and controls the power supply circuit 50 relating to the polarity inversion timing of the voltage level of the common electrode voltage VCOM applied to the common electrode CE, for example.

The power supply circuit 50 generates various voltage levels (grayscale voltages) necessary for driving the display panel 12 and the voltage level of the common electrode voltage VCOM applied to the common electrode CE based on a reference voltage supplied from the outside.

In the liquid crystal display device 10 having such a configuration, the source driver 20, the gate driver 38, and the power supply circuit 50 cooperate to drive the display panel 12 based on grayscale data supplied from the outside under control of the display controller 40.

FIG. 1 shows an example in which one pixel includes three dots for displaying the RGB color components and the source lines are provided in color component units. Note that one pixel may include two dots or four or more dots.

In FIG. 1, the liquid crystal display device 10 includes the display controller 40. Note that the display controller 40 may be provided outside the liquid crystal display device 10. Alternatively, the liquid crystal display device 10 may include the host together with the display controller 40. Some or all of the source driver 20, the gate driver 38, the display controller 40, and the power supply circuit 50 may be formed on the display panel 12.

In FIG. 1, a display driver 60 may be formed as a semiconductor device (integrated circuit (IC)) by integrating the source driver 20, the gate driver 38, and the power supply circuit 50.

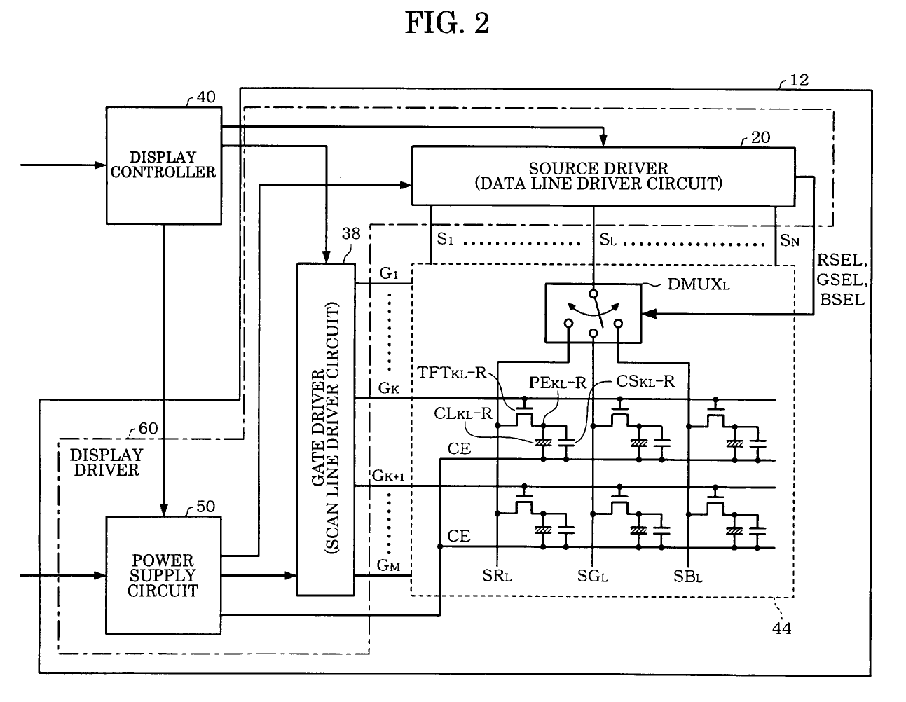

FIG. 2 shows another configuration example of the liquid crystal display device according to this embodiment.

In FIG. 2, the display driver 60 which includes the source driver 20, the gate driver 38, and the power supply circuit 50 is formed on the display panel 12 (panel substrate). Specifically, the display panel 12 may be configured to include a plurality of gate lines, a plurality of source lines, a plurality of pixels (pixel electrodes), each of which is connected to the corresponding gate line and the corresponding source line, a source driver which drives the source lines, and a gate driver which scans the gate lines. The pixels are formed in a pixel formation region 44 of the display panel 12. Each pixel may include a TFT, of which the source is connected to the source line and the gate is connected to the gate line, and a pixel electrode connected to the drain of the TFT.

In FIG. 2, at least one of the gate driver 38 and the power supply circuit 50 may be omitted from the display panel 12.

In FIG. 1 or 2, the display driver 60 may include the display controller 40. In FIG. 1 or 2, the display driver 60 may be a semiconductor device formed by integrating the source driver 20 or the gate driver 38 and the power supply circuit 50.

1.1 Gate Driver

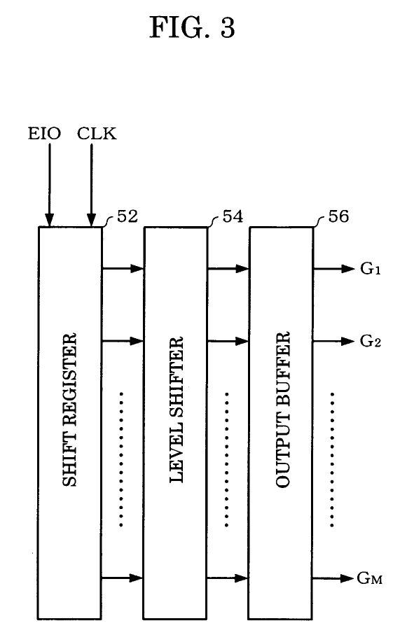

FIG. 3 shows a configuration example of the gate driver 38 shown in FIG. 1 or 2.

The gate driver 38 includes a shift register 52, a level shifter 54, and an output buffer 56.

The shift register 52 includes a plurality of flip-flops which are provided corresponding to the gate lines and sequentially connected. The shift register 52 holds an enable input-output signal EIO in the flip-flop in synchronization with a clock signal CLK, and sequentially shifts the enable input-output signal EIO to the adjacent flip-flops in synchronization with the clock signal CLK. The enable input-output signal EIO input to the shift register 52 is a vertical synchronization signal supplied from the display controller 40.

The level shifter 54 shifts the voltage level from the shift register 52 to a voltage level corresponding to the liquid crystal element of the display panel 12 and the transistor performance of the TFT. Since a high voltage level is required as the above voltage level, a high voltage process differing from that of other logic circuit sections is used for the level shifter 54.

The output buffer 56 buffers a scan voltage shifted by the level shifter 54, and outputs the scan voltage to the gate line to drive the gate line.

1.2 Source Driver

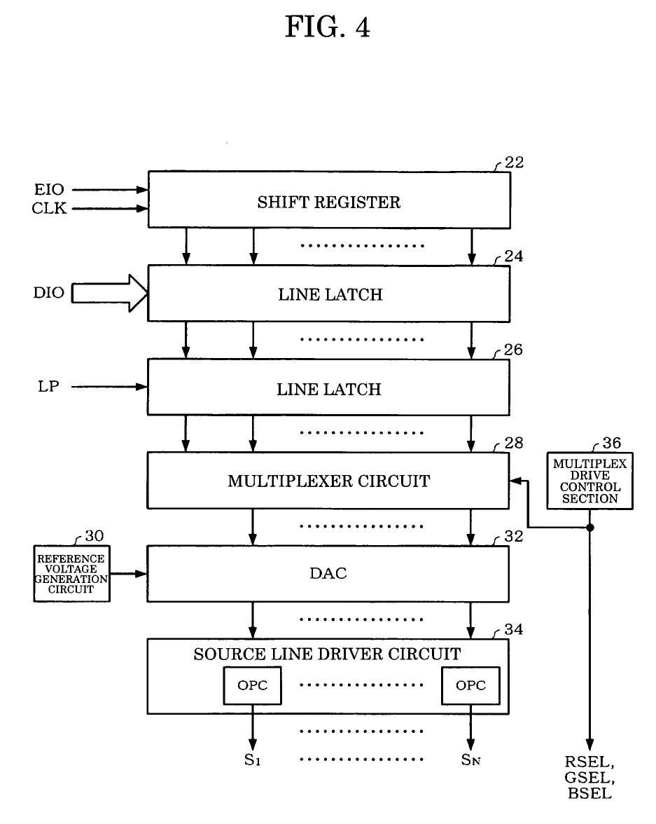

FIG. 4 is a block diagram showing a configuration example of the source driver 20 shown in FIG. 1 or 2.

The source driver 20 includes a shift register 22, line latches 24 and 26, a multiplexer circuit 28, a reference voltage generation circuit 30, a digital-to-analog converter (DAC) 32 (data voltage generation circuit in a broad sense), a source line driver circuit 34, and a multiplex drive control section 36.

The shift register 22 includes a plurality of flip-flops which are provided corresponding to the source lines and sequentially connected. The shift register 22 holds the enable input-output signal EIO in synchronization with the clock signal CLK, and sequentially shifts the enable input-output signal EIO to the adjacent flip-flops in synchronization with the clock signal CLK.

Grayscale data (DIO) is input to the line latch 24 from the display controller 40 in units of 18 bits (6 bits (grayscale data)×3 (RGB)), for example. The line latch 24 latches the grayscale data (DIO) in synchronization with the enable input-output signal EIO which is sequentially shifted by the flip-flops of the shift register 22.

The line latch 26 latches the grayscale data of one horizontal scan latched by the line latch 24 in synchronization with a horizontal synchronization signal LP supplied from the display controller 40.

The multiplexer circuit 28 time-division multiplexes the grayscale data of three source lines latched by the line latch 26 corresponding to the respective source lines.

The multiplex drive control section 36 generates multiplex control signals RSEL, GSEL, and BSEL which specify the time division timing of the grayscale voltage supplied to the source voltage supply line. Specifically, the multiplex drive control section 36 generates the multiplex control signals RSEL, GSEL, and BSEL so that the multiplex control signals RSEL, GSEL, and BSEL alternately become active within one horizontal scan period. The multiplexer circuit 28 multiplexes the grayscale data based on the multiplex control signals RSEL, GSEL, and BSEL so that the grayscale voltages are supplied to the source voltage supply line by time division. The multiplex control signals RSEL, GSEL, and BSEL are also supplied to the demultiplexers DMUX₁ to DMUX_{N} of the display panel 12.

the reference voltage generation circuit 30 generates 64 (=2⁶) reference voltages. The 64 reference voltages generated by the reference voltage generation circuit 30 are supplied to the DAC 32.

The DAC (data voltage generation circuit) 32 generates an analog data voltage supplied to each source line. Specifically, the DAC 32 selects one of the reference voltages supplied from the reference voltage generation circuit 30 based on the digital grayscale data supplied from the multiplexer circuit 28, and outputs an analog data voltage corresponding to the digital grayscale data.

The source line driver circuit 34 buffers the data voltage supplied from the DAC 32, and outputs the data voltage to the source line to drive the source line. Specifically, the source line driver circuit 34 includes voltage-follower-connected operational amplifiers OPC (impedance conversion circuits in a broad sense) provided corresponding to the source lines. Each operational amplifier circuit OPC subjects the data voltage supplied from the DAC 32 to impedance conversion, and outputs the resulting data voltage to the corresponding source line.

FIG. 4 employs a configuration in which the digital grayscale data is subjected to digital-analog conversion and is output to the source line through the source line driver circuit 34. Note that a configuration may also be employed in which an analog image signal is sampled/held and output to the source line through the source line driver circuit 34.

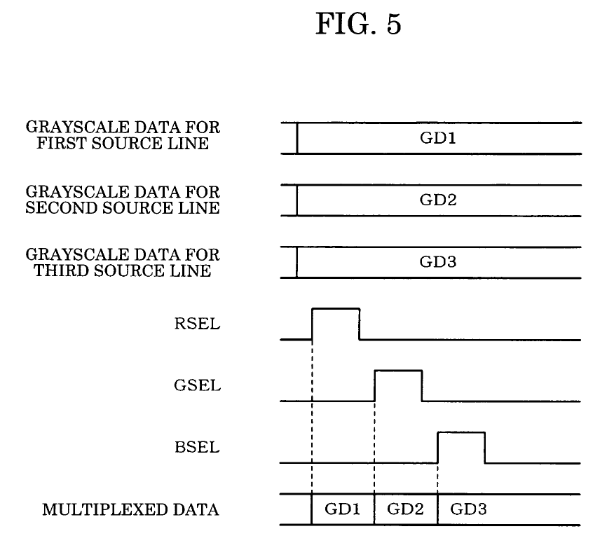

FIG. 5 is a view illustrative of the operation of the multiplexer circuit 28 shown in FIG. 4.

In FIG. 5, grayscale data for first to third source lines multiplexed by the multiplexer circuit 28 is referred to as GD1, GD2, and GD3, respectively. Each of the multiplex control signals RSEL, GSEL, and BSEL generated by the multiplex drive control section 36 becomes active once within one horizontal scan period, for example. The multiplexer circuit 28 selectively outputs the grayscale data GD1 for the first source line when the multiplex control signal RSEL has become active, selectively outputs the grayscale data GD2 for the second source line when the multiplex control signal GSEL has become active, and selectively outputs the grayscale data GD3 for the third source line when the multiplex control signal BSEL has become active. As a result, the multiplexer circuit 28 generates multiplexed data in which the grayscale data GD1 to GD3 for the first to third source lines is time-division multiplexed, and supplies the multiplexed data to the DAC 32.

Each decoder of the DAC 32 selects the grayscale voltages corresponding to the grayscale data GD1 to GD3 for the first to third source lines multiplexed into the multiplexed data from the 64 reference voltages. As a result, each decoder of the DAC 32 outputs a grayscale voltage in which first to third grayscale voltages are multiplexed corresponding to the multiplexed data. Specifically, the DAC 32 generates the first to third grayscale voltages respectively corresponding to the grayscale data multiplexed by the multiplexer circuit 28.

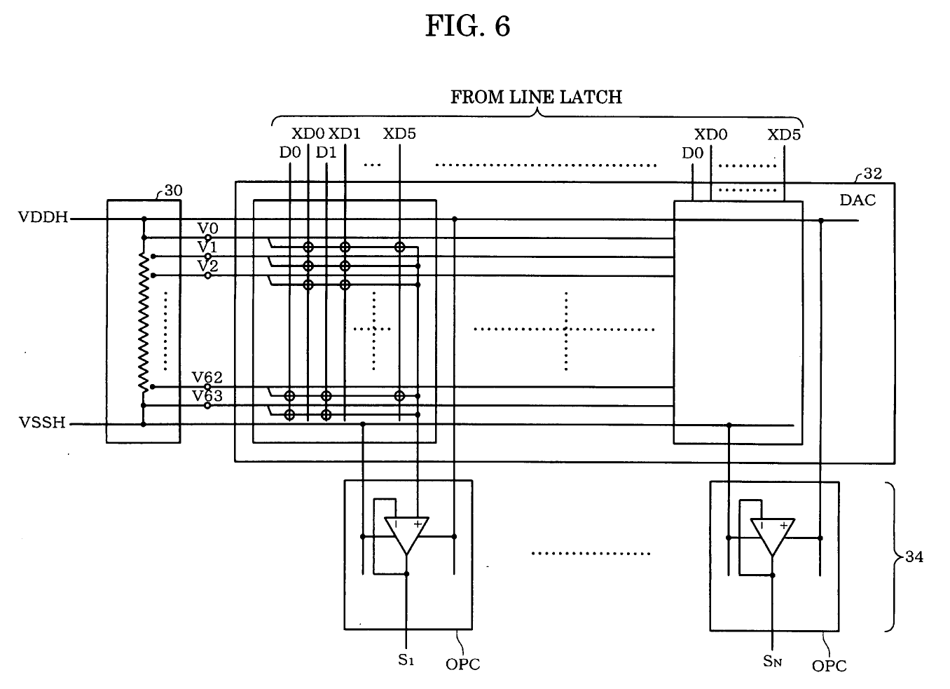

FIG. 6 shows a configuration example of the reference voltage generation circuit 30, the DAC 32, and the source line driver circuit 34 shown in FIG. 4. In FIG. 6, the grayscale data is made up of 6-bit data D0 to D5, and inversion data of each bit of the grayscale data is indicated by XD0 to XD5. In FIG. 6, the same sections as in FIG. 4 are indicated by the same symbols. Description of these sections is appropriately omitted.

The reference voltage generation circuit 30 generates 64 reference voltages by dividing the voltage between voltages VDDH and VSSH using resistors. Each reference voltage corresponds to a grayscale value indicated by the 6-bit grayscale data. Each reference voltage is supplied in common to the source voltage supply lines S₁ to S_{N}.

The DAC 32 includes decoders provided corresponding to the source voltage supply lines (source lines). Each decoder outputs the reference voltage corresponding to the grayscale data to the operational amplifier OPC. The first to third grayscale voltages output from each decoder of the DAC 32 are subjected to impedance conversion by the corresponding operational amplifier of the source line driver circuit 34. The output from each operational amplifier OPC of the source line driver circuit 34 is supplied to the demultiplexer of the display panel 12 through the source voltage supply line.

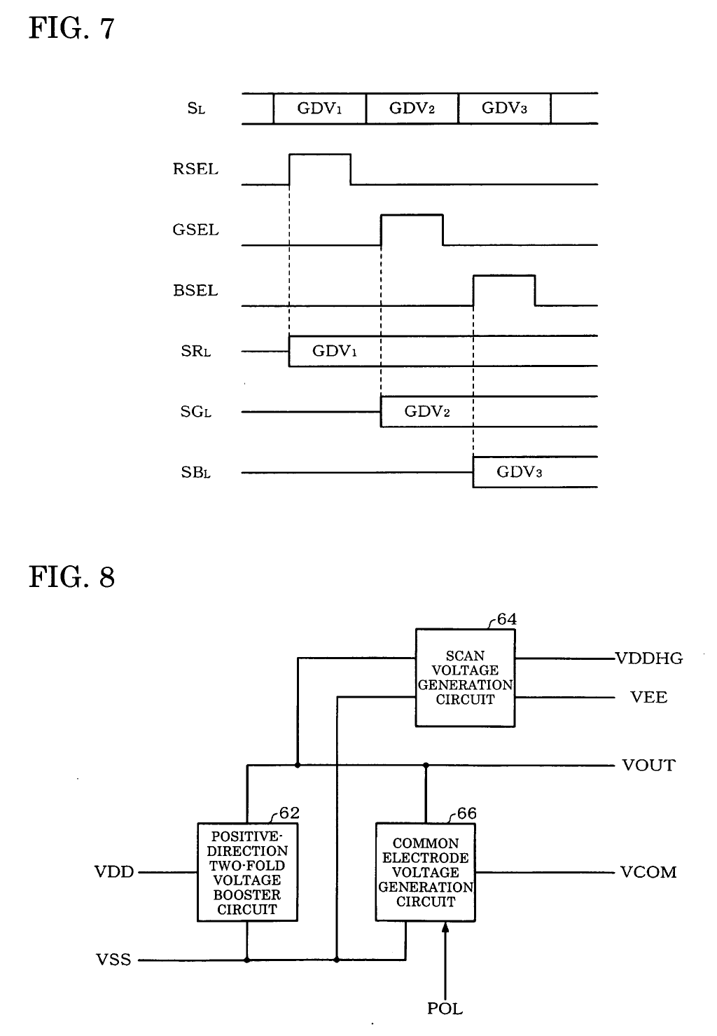

FIG. 7 is a view illustrative of the operation of the demultiplexer shown in FIG. 1 or 2.

FIG. 7 shows an operation example of the demultiplexer DMUX_{L} which separates the grayscale voltages supplied to the source voltage supply line S_{L} by time division and supplies the separated grayscale voltages to the source lines SR_{L}, SG_{L}, and SB_{L}. Note that the following description also applies to other demultiplexers.

The demultiplexer DMUX_{L} separates the grayscale voltages which are supplied to the source voltage supply line S_{L} and in which grayscale voltages GDV₁, GDV₂, and GDV₃ are multiplexed using the multiplex control signals RSEL, GSEL, and BSEL, and outputs the separated grayscale voltages to the source lines SR_{L}, SG_{L}, and SB_{L}.

Specifically, the demultiplexer DMUX_{L} outputs the multiplexed grayscale voltage (first grayscale voltage GDV₁) to the source line SRI as the first source line when the multiplex control signal RSEL is active, outputs the multiplexed grayscale voltage (second grayscale voltage GDV₂) to the source line SG_{L} as the second source line when the multiplex control signal GSEL is active, and outputs the multiplexed grayscale voltage (third grayscale voltage GDV₃) to the source line SB_{L} as the third source line when the multiplex control signal BSEL is active.

This enables the grayscale voltage to be supplied to the source of the TFT connected to the selected gate line of the display panel 12.

1.3 Power Supply Circuit

FIG. 8 shows a configuration example of the power supply circuit 50 shown in FIG. 1 or 2.

The power supply circuit 50 includes a positive-direction two-fold voltage booster circuit 62, a scan voltage generation circuit 64, and a common electrode voltage generation circuit 66. A system ground power supply voltage VSS and a system power supply voltage VDD are supplied to the power supply circuit 50.

The system ground power supply voltage VSS and the system power supply voltage VDD are supplied to the positive-direction two-fold voltage booster circuit 62. The positive-direction two-fold voltage booster circuit 62 generates a power supply voltage VOUT by raising the system power supply voltage VDD in the positive direction by a factor of two with respect to the system ground power supply voltage VSS. Specifically, the positive-direction two-fold voltage booster circuit 62 increases the voltage difference between the system ground power supply voltage VSS and the system power supply voltage VDD by a factor of two. The positive-direction two-fold voltage booster circuit 62 may be formed using a known charge-pump circuit. The power supply voltage VOUT is supplied to the source driver 20, the scan voltage generation circuit 64, and the common electrode voltage generation circuit 66. It is desirable that the positive-direction two-fold voltage booster circuit 62 output the power supply voltage VOUT obtained by raising the system power supply voltage VDD in the positive direction by a factor of two by raising the system power supply voltage VDD by a factor equal to or larger than two and then regulating the voltage level using a regulator.

The system ground power supply voltage VSS and the power supply voltage VOUT are supplied to the scan voltage generation circuit 64. The scan voltage generation circuit 64 generates the scan voltage. The scan voltage is a voltage applied to the gate line driven by the gate driver 38. The high-potential-side voltage and the low-potential-side voltage of the scan voltage are voltages VDDHG and VEE, respectively.

The common electrode voltage generation circuit 66 generates the common electrode voltage VCOM. The common electrode voltage generation circuit 66 outputs the high-potential-side voltage VCOMH or the low-potential-side voltage VCOML as the common electrode voltage VCOM based on a polarity inversion signal POL. The polarity inversion signal POL is generated by the display controller 40 in synchronization with the polarity inversion timing.

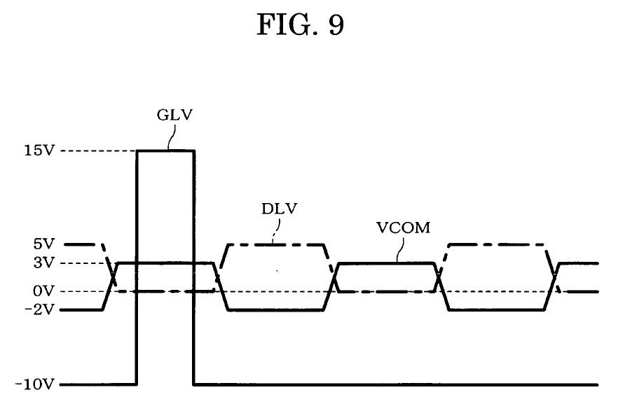

FIG. 9 shows an example of the drive waveform of the display panel 12 shown in FIG. 1 or 2.

A grayscale voltage DLV corresponding to the grayscale value of the grayscale data is applied to the source line. In FIG. 9, the grayscale voltage DLV having an amplitude of 5 V with respect to the system ground power supply voltage VSS (=0 V) is applied to the source line.

A scan voltage GLV at the low-potential-side voltage VEE (=−10 V) is applied to the gate line as an unselect voltage in an unselected state, and a scan voltage GLV at the high-potential-side voltage VDDHG (=15 V) is applied to the gate line as a select voltage in a selected state.

The common electrode voltage VCOM at the high-potential-side voltage VCOMH (=3 V) or the low-potential-side voltage VCOML (=−2 V) is applied to the common electrode CE. The polarity of the voltage level of the common electrode voltage VCOM is reversed with respect to a given voltage in synchronization with the polarity inversion timing. FIG. 9 shows the waveform of the common electrode voltage VCOM during scan line inversion drive. The polarity of the grayscale voltage DLV applied to the source line is also reversed with respect to a given voltage in synchronization with the polarity inversion timing.

A liquid crystal element deteriorates when a direct-current voltage is applied to the liquid crystal element for a long period of time. This makes it necessary to employ a drive method which reverses the polarity of the voltage applied to the liquid crystal element each time a given period has expired. As such a drive method, frame inversion drive, scan (gate) line inversion drive, data (source) line inversion drive, dot inversion drive, and the like are known.

Frame inversion drive reduces power consumption, but results in a poor image quality. Data line inversion drive and dot inversion drive provide an excellent image quality, but require a high voltage for driving a display panel.

This embodiment employs scan line inversion drive. In scan line inversion drive, the polarity of the voltage applied to the liquid crystal element is reversed each time a scan period has expired (i.e., scan line units). For example, a positive voltage is applied to the liquid crystal element in the first scan period (scan line), a negative voltage is applied to the liquid crystal element in the second scan period, and a positive voltage is applied to the liquid crystal element in the third scan period. In the subsequent frame, a negative voltage is applied to the liquid crystal element in the first scan period, a positive voltage is applied to the liquid crystal element in the second scan period, and a negative voltage is applied to the liquid crystal element in the third scan period.

In scan line inversion drive, the polarity of the voltage level of the common electrode voltage VCOM applied to the common electrode CE is reversed each time the scan period has expired.

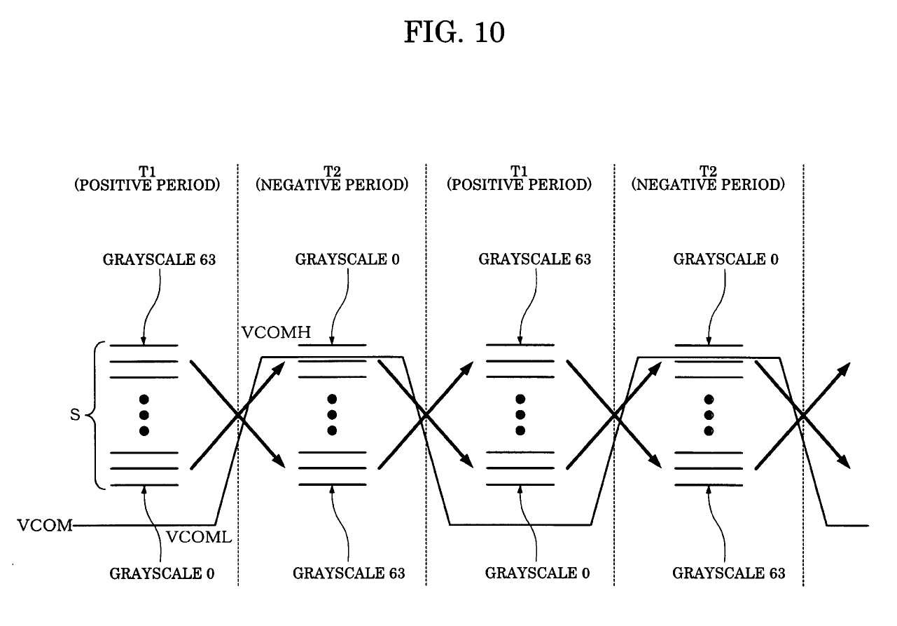

Specifically, the voltage level of the common electrode voltage VCOM is set at the low-potential-side voltage VCOML in a positive period T1 (first period), and is set at the high-potential-side voltage VCOMH in a negative period T2 (second period), as shown in FIG. 10. The polarity of the grayscale voltage applied to the source line is also reversed at the above timing. Note that the voltage level of the low-potential-side voltage VCOML is the reverse of that of the high-potential-side voltage VCOMH with respect to a given voltage level.

The positive period T1 refers to a period in which the voltage level of the pixel electrode to which the grayscale voltage is supplied through the source line is higher than the voltage level of the common electrode CE. In the positive period T1, a positive voltage is applied to the liquid crystal element. The negative period T2 refers to a period in which the voltage level of the pixel electrode to which the grayscale voltage is supplied through the source line is lower than the voltage level of the common electrode CE. In the negative period T2, a negative voltage is applied to the liquid crystal element.

A voltage necessary for driving the display panel can be reduced by thus reversing the polarity of the common electrode voltage VCOM. This makes it possible to reduce the withstand voltage of the driver circuit, thereby simplifying the driver circuit manufacturing process and reducing the manufacturing cost.

2. Common Electrode Voltage Generation Circuit

The common electrode voltage generation circuit according to this embodiment suppresses a change in common electrode voltage without increasing power consumption even if the load capacitance of the common electrode increases at the common electrode voltage switch timing due to polarity inversion drive or the multiplex drive timing at which the common electrode voltage changes due to capacitive coupling.

2.1 First Configuration Example

A common electrode voltage generation circuit according to a comparative example of this embodiment is described below before describing a common electrode voltage generation circuit according to a first configuration example.

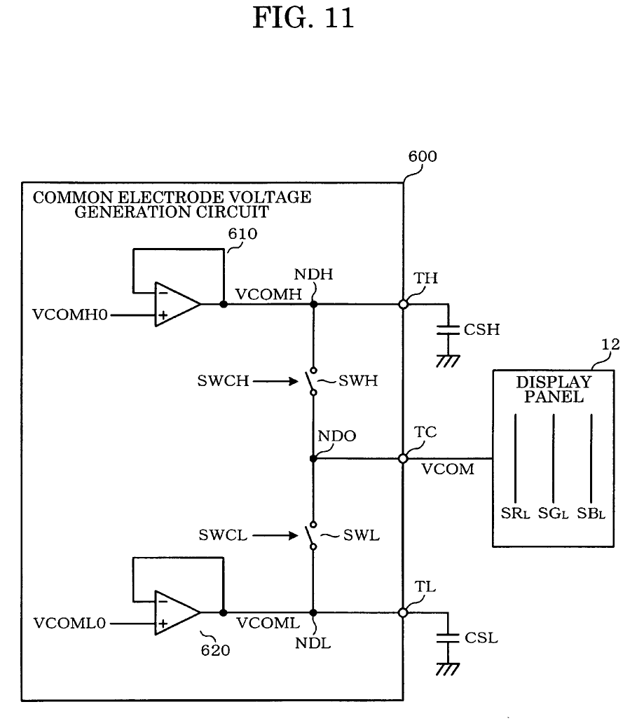

FIG. 11 is a block diagram showing a configuration example of a common electrode voltage generation circuit according to the comparative example of this embodiment.

A common electrode voltage generation circuit 600 according to the comparative example includes a VCOMH generation circuit (high-potential-side voltage generation circuit) 610 to which a reference high-potential-side voltage VCOMH0 is input, and a VCOML generation circuit (low-potential-side voltage generation circuit) 620 to which a reference low-potential-side voltage VCOML 0 is input. The VCOMH generation circuit 610 is a voltage-follower-connected operational amplifier. The VCOML generation circuit 620 is also a voltage-follower-connected operational amplifier. The common electrode voltage generation circuit 600 includes switch circuits SWH and SWL provided between an output node NDH of the VCOMH generation circuit 610 and an output node NDL of the VCOML generation circuit 620. The switch circuits SWH and SWL are connected in series between the output nodes NDH and NDL, and are ON/OFF-controlled so that the switch circuits SWH and SWL are not turned ON at the same time. A switch control signal SWCH for switch-controlling the switch circuit SWH is generated based on the polarity inversion signal POL. A switch control signal SWCL for switch-controlling the switch circuit SWL is also generated based on the polarity inversion signal POL.

One end of a high-potential-side stabilization capacitor element CSH is electrically connected to the output node NDH outside the common electrode voltage generation circuit 600 through a terminal TH of the common electrode voltage generation circuit 600. The system ground power supply voltage VSS is supplied to the other end of the high-potential-side stabilization capacitor element CSH.

One end of a low-potential-side stabilization capacitor element CSL is electrically connected to the output node NDL outside the common electrode voltage generation circuit 600 through a terminal TL of the common electrode voltage generation circuit 600. The system ground power supply voltage VSS is supplied to the other end of the low-potential-side stabilization capacitor element CSL.

A connection node of the switch circuits SWH and SWL is an output node NDO of the common electrode voltage generation circuit 600. The output node NDO is electrically connected to the common electrode of the display panel 12 through a terminal TC of the common electrode voltage generation circuit 600.

The above configuration enables the common electrode voltage generation circuit 600 to output the high-potential-side voltage VCOMH or the low-potential-side voltage VCOML as the common electrode voltage VCOM based on the polarity inversion signal POL.

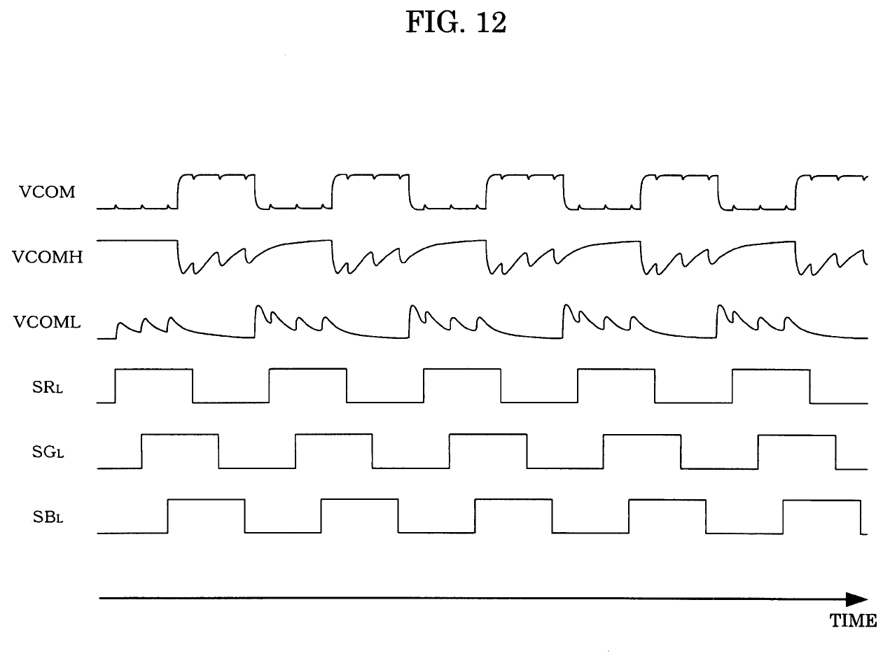

FIG. 12 is a simulation waveform diagram showing an operation example of the common electrode voltage generation circuit 600 shown in FIG. 11. In FIG. 12, the amplitude of the waveform of the common electrode voltage VCOM differs from the amplitudes of the waveforms of the high-potential-side voltage VCOMH and the low-potential-side voltage VCOML so that the operation waveform can be readily understood.

In FIG. 12, the high-potential-side voltage VCOMH and the low-potential-side voltage VCOML change due to two factors. The first factor is switching of the common electrode voltage VCOM. Specifically, when switching the common electrode voltage VCOM from the high-potential-side voltage VCOMH to the low-potential-side voltage VCOML, a charge is redistributed between the load capacitor of the common electrode CE and the low-potential-side stabilization capacitor element CSL. As a result, the output potential of the VCOML generation circuit 620 changes. Likewise, when switching the common electrode voltage VCOM from the low-potential-side voltage VCOML to the high-potential-side voltage VCOMH, a charge is redistributed between the load capacitor of the common electrode CE and the high-potential-side stabilization capacitor element CSH. As a result, the output potential of the VCOMH generation circuit 610 changes.

The second factor is a change in the potential of the source line due to multiplex drive. Specifically, when the potential of the source line SR_{L} (SG_{L} or SB_{L}) changes from a negative potential to a positive potential, the potential level of the common electrode CE changes due to capacitive coupling between the source line SR_{L} and the common electrode CE. Likewise, when the potential of the source line SR_{L} (SG_{L} or SB_{L}) changes from a positive potential to a negative potential, the potential level of the common electrode CE changes due to capacitive coupling between the source line SR_{L} and the common electrode CE.

When the potential level of the common electrode CE changes, the voltage applied to the liquid crystal changes, whereby image quality deteriorates. Therefore, image quality is improved by stabilizing the potential level of the common electrode CE. A change in the potential level of the common electrode CE has been generally absorbed by increasing the current drive capability of a circuit which drives the common electrode CE. However, it is necessary to increase the operating current of the circuit in order to increase its current drive capability. When the load capacitance of the common electrode increases due to an increase in the screen size of the display panel 12, the operating current of the circuit must be increased to a large extent. As a result, power consumption increases.

In this embodiment, a change in the potential level of the common electrode CE is significantly reduced by dividing the stabilization capacitor element as described below to reduce the crosstalk.

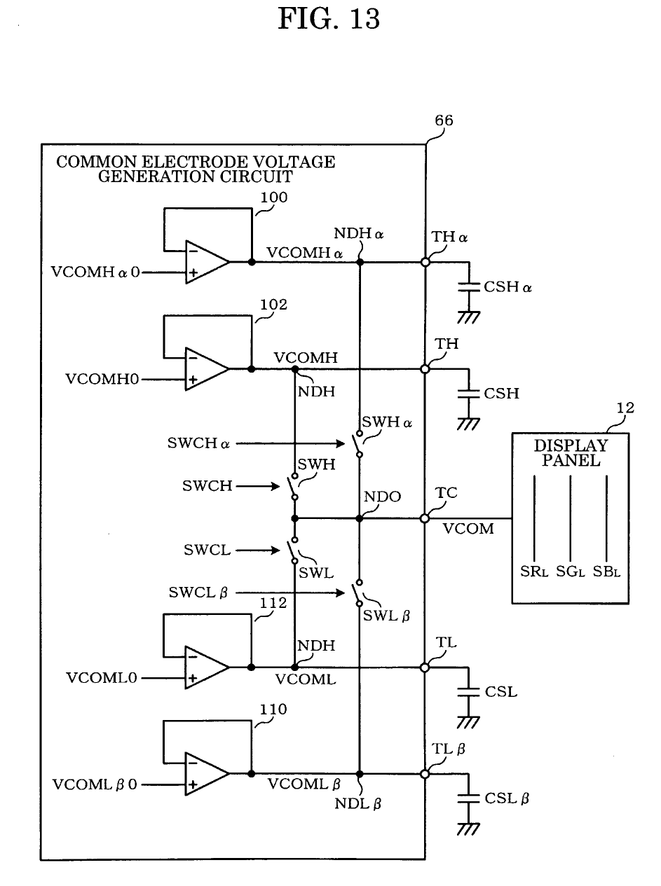

FIG. 13 is a block diagram showing a configuration example of a common electrode voltage generation circuit according to a first configuration example of this embodiment.

The common electrode voltage generation circuit 66 according to the first configuration example may include first and second VCOMH generation circuits (first and second high-potential-side voltage generation circuits) 100 and 102.

A first reference high-potential-side voltage VCOMHα is input to the first VCOMH generation circuit 100. The first VCOMH generation circuit 100 includes a voltage-follower-connected operational amplifier, for example. The first VCOMH generation circuit 100 outputs a first high-potential-side voltage VCOMHα. One end of a first high-potential-side stabilization capacitor element CSHα is electrically connected to an output node NDHα of the first VCOMH generation circuit 100 through a terminal THα of the common electrode voltage generation circuit 66. The system ground power supply voltage VSS is supplied to the other end of the first high-potential-side stabilization capacitor element CSHα.

A second reference high-potential-side voltage VCOMH0 is input to the second VCOMH generation circuit 102. The second VCOMH generation circuit 102 includes a voltage-follower-connected operational amplifier, for example. The second VCOMH generation circuit 102 outputs a second high-potential-side voltage VCOMH. One end of a second high-potential-side stabilization capacitor element CSH is electrically connected to an output node NDH of the second VCOMH generation circuit 102 through a terminal TH of the common electrode voltage generation circuit 66. The system ground power supply voltage VSS is supplied to the other end of the second high-potential-side stabilization capacitor element CSH.

When supplying the high-potential-side voltage VCOMH to the common electrode CE of the display panel 12, the common electrode voltage generation circuit 66 electrically connects the output of the first VCOMH generation circuit 100 to the common electrode CE, and then electrically connects the output of the second VCOMH generation circuit 102 to the common electrode CE. Therefore, the second high-potential-side voltage VCOMH is supplied to the common electrode CE after the first high-potential-side voltage VCOMHα has been supplied to the common electrode CE.

Accordingly, when the common electrode voltage VCOM changes from the low-potential-side voltage to the high-potential-side voltage, a charge is redistributed between the common electrode CE and the first high-potential-side stabilization capacitor element CSHα. Therefore, a change in the potential of the common electrode CE is absorbed by the first high-potential-side stabilization capacitor element CSHα. Since the second high-potential-side voltage VCOMH is then supplied to the common electrode CE due to a charge stored in the second high-potential-side stabilization capacitor element CSH, a change in the potential of the high-potential-side voltage of the common electrode CE can be reduced. This also applies to the case where the potential of the source line changes due to multiplex drive. Specifically, since the second high-potential-side voltage VCOMH is supplied to the common electrode CE due to a charge stored in the second high-potential-side stabilization capacitor element CSH, a change in the potential of the high-potential-side voltage of the common electrode CE can be reduced.

It is desirable that the first high-potential-side voltage VCOMHα be higher in potential than the second high-potential-side voltage VCOMH. This reduces a decrease in the voltage of the common electrode CE, whereby the voltage of the common electrode CE can be quickly stabilized at the potential level of the high-potential-side voltage VCOMH when switching the common electrode voltage VCOM from the low-potential-side voltage to the high-potential-side voltage.

The capacitance of the first high-potential-side stabilization capacitor element CSHα may be smaller than the capacitance of the second high-potential-side stabilization capacitor element CSH. This is because the accuracy of the potential of the high-potential-side voltage VCOMH applied to the common electrode CE is determined by the capacitance of the second high-potential-side stabilization capacitor element CSH. As a result, the mounting area of the stabilization capacitor element and the cost of the system including the common electrode voltage generation circuit 66 can be reduced.

The common electrode voltage generation circuit 66 may include first and second VCOML generation circuits (first and second low-potential-side voltage generation circuits) 110 and 112.

A first reference low-potential-side voltage VCOMLβ0 is input to the first VCOML generation circuit 110. The first VCOML generation circuit 110 includes a voltage-follower-connected operational amplifier, for example. The first VCOML generation circuit 110 outputs a first low-potential-side voltage VCOMLβ. One end of a first low-potential-side stabilization capacitor element CSLβ is electrically connected to an output node NDLβ of the first VCOML generation circuit 110 through a terminal TLβ of the common electrode voltage generation circuit 66. The system ground power supply voltage VSS is supplied to the other end of the first low-potential-side stabilization capacitor element CSLβ.

A second reference low-potential-side voltage VCOML 0 is input to the second VCOML generation circuit 112. The second VCOML generation circuit 112 includes a voltage-follower-connected operational amplifier, for example. The second VCOML generation circuit 112 outputs a second low-potential-side voltage VCOML. One end of a second low-potential-side stabilization capacitor element CSL is electrically connected to an output node NDL of the second VCOML generation circuit 112 through a terminal TL of the common electrode voltage generation circuit 66. The system ground power supply voltage VSS is supplied to the other end of the second low-potential-side stabilization capacitor element CSL.

When supplying the low-potential-side voltage VCOML to the common electrode CE of the display panel 12, the common electrode voltage generation circuit 66 electrically connects the output of the first VCOML generation circuit 110 to the common electrode CE, and then electrically connects the output of the second VCOML generation circuit 112 to the common electrode CE. Therefore, the first low-potential-side voltage VCOML is supplied to the common electrode CE after the first low-potential-side voltage VCOMLβ has been supplied to the common electrode CE.

Accordingly, when the common electrode voltage VCOM changes from the high-potential-side voltage to the low-potential-side voltage, a charge is redistributed between the common electrode CE and the first low-potential-side stabilization capacitor element CSLβ. Therefore, a change in the potential of the common electrode CE is absorbed by the first low-potential-side stabilization capacitor element CSLβ. Since the second low-potential-side voltage VCOML is then supplied to the common electrode CE due to a charge stored in the second low-potential-side stabilization capacitor element CSL, a change in the potential of the low-potential-side voltage of the common electrode CE can be reduced. This also applies to the case where the potential of the source line changes due to multiplex drive. Specifically, since the second low-potential-side voltage VCOML is supplied to the common electrode CE due to a charge stored in the second low-potential-side stabilization capacitor element CSL, a change in the potential of the low-potential-side voltage of the common electrode CE can be reduced.

It is desirable that the first low-potential-side voltage VCOMLβ be lower in potential than the second low-potential-side voltage VCOML. This reduces an increase in the voltage of the common electrode CE, whereby the voltage of the common electrode CE can be quickly stabilized at the potential level of the low-potential-side voltage VCOML when switching the common electrode voltage VCOM from the high-potential-side voltage to the low-potential-side voltage.

The capacitance of the first low-potential-side stabilization capacitor element CSLβ may be smaller than the capacitance of the second low-potential-side stabilization capacitor element CSL. This is because the accuracy of the potential of the low-potential-side voltage VCOML applied to the common electrode CE is determined by the capacitance of the second low-potential-side stabilization capacitor element CSL. As a result, the mounting area of the stabilization capacitor element and the cost of the system including the common electrode voltage generation circuit 66 can be reduced.

The common electrode voltage generation circuit 66 includes switch circuits SWHα and SWLβ provided between the output node NDHα of the first VCOMH generation circuit 100 and the output node NDLβ of the first VCOML generation circuit 110. The common electrode voltage generation circuit 66 also includes switch circuits SWH and SWL provided between the output node NDH of the second VCOMH generation circuit 102 and the output node NDL of the second VCOML generation circuit 112. A connection node of the switch circuits SWHα and SWLβ is electrically connected to the output node NDO. A connection node of the switch circuits SWH and SWL is electrically connected to the output node NDO.

The switch circuit SWHα is switch-controlled using a switch control signal SWCHα. The switch circuit SWLβ is switch-controlled using a switch control signal SWCLβ. The switch circuits SWHα and SWLβ are switch-controlled so that the switch circuits SWHα and SWLβ are not turned ON at the same time. The switch control signals SWCHα and SWCLβ are generated based on the polarity inversion signal POL.

The switch circuit SWH is switch-controlled using a switch control signal SWCH. The switch circuit SWL is switch-controlled using a switch control signal SWCL. The switch circuits SWH and SWL are switch-controlled so that the switch circuits SWH and SWL are not turned ON at the same time. The switch control signals SWCH and SWCL are generated based on the polarity inversion signal POL.

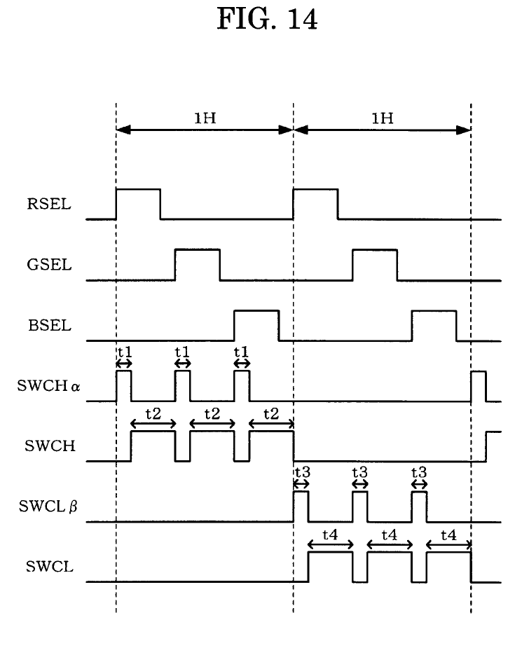

FIG. 14 is a timing diagram showing a control example of the common electrode voltage generation circuit 66 shown in FIG. 13.

In FIG. 14, the multiplex control signals RSEL, GSEL, and BSE alternately become active so that multiplex drive which writes the grayscale voltage into the pixel electrode is performed in each of three periods into which one horizontal scan period (1 H) is divided.

In this case, when supplying the high-potential-side voltage to the common electrode CE, the common electrode voltage generation circuit 66 electrically connects the output of the first VCOMH generation circuit 100 to the common electrode CE and then electrically connects the output of the second VCOMH generation circuit 102 to the common electrode CE in each period. Therefore, the switch control signal SWCHα becomes active and the switch control signal SWCH then becomes active in each period into which one horizontal scan period is divided.

It is desirable that a period t1 in which the output of the first VCOMH generation circuit 100 is electrically connected to the common electrode CE be shorter than a period t2 in which the output of the second VCOMH generation circuit 102 is electrically connected to the common electrode CE. Specifically, a change in the potential level of the high-potential-side voltage of the common electrode CE can be reduced as the period t2 in which the output of the second VCOMH generation circuit 102 is electrically connected to the common electrode CE increases.

Likewise, when supplying the low-potential-side voltage to the common electrode CE, the common electrode voltage generation circuit 66 electrically connects the output of the first VCOML generation circuit 110 to the common electrode CE and then electrically connects the output of the second VCOML generation circuit 112 to the common electrode CE in each period. Therefore, the switch control signal SWCLβ becomes active and the switch control signal SWCL then becomes active in each period into which one horizontal scan period is divided.

It is desirable that a period t3 in which the output of the first VCOML generation circuit 110 is electrically connected to the common electrode CE be shorter than a period t4 in which the output of the second VCOML generation circuit 112 is electrically connected to the common electrode CE. Specifically, a change in the potential level of the low-potential-side voltage of the common electrode CE can be reduced as the period t4 in which the output of the second VCOML generation circuit 112 is electrically connected to the common electrode CE increases.

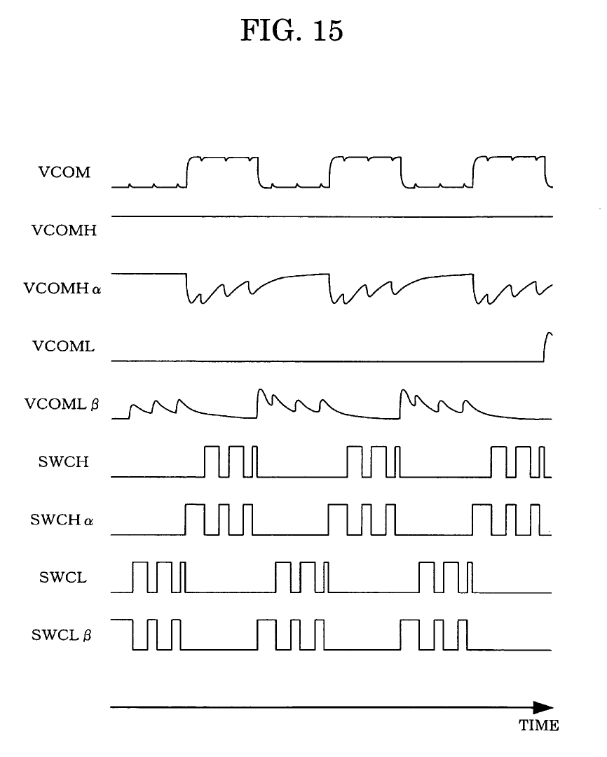

FIG. 15 is a simulation waveform diagram showing an operation example of the common electrode voltage generation circuit 66 according to the first configuration example. In FIG. 15, the amplitude of the waveform of the common electrode voltage VCOM differs from the amplitudes of the waveforms of the high-potential-side voltage VCOMH and the low-potential-side voltage VCOML so that the operation waveform can be readily understood.

In FIG. 15, when switching the common electrode voltage VCOM from the high-potential-side voltage to the low-potential-side voltage, a charge is redistributed between the load capacitor of the common electrode CE and the first low-potential-side stabilization capacitor element CSLβ. As a result, the output potential of the first VCOML generation circuit 110 changes. The output of the second VCOML generation circuit 112 is then electrically connected to the common electrode CE. However, since the amount of charge redistributed between the load capacitor of the common electrode CE and the second low-potential-side stabilization capacitor element CSL is small, the output potential of the second VCOML generation circuit 112 changes to only a small extent. Likewise, when switching the common electrode voltage VCOM from the low-potential-side voltage to the high-potential-side voltage, a charge is redistributed between the load capacitor of the common electrode CE and the first high-potential-side stabilization capacitor element CSHα. As a result, the output potential of the first VCOMH generation circuit 100 changes. The output of the second VCOMH generation circuit 102 is then electrically connected to the common electrode CE. However, since the amount of charge redistributed between the load capacitor of the common electrode CE and the second high-potential-side stabilization capacitor element CSH is small, the output potential of the second VCOMH generation circuit 102 changes to only a small extent.

When the potential of the source line changes from the negative potential to the positive potential or changes from the positive potential to the negative potential, the output potential of the first VCOML generation circuit 110 or the first VCOMH generation circuit 100 changes, but the output potential of the second VCOML generation circuit 112 or the second VCOMH generation circuit 102 does not change.

Therefore, since a change in the potential level of the common electrode CE can be reduced without driving the common electrode CE with a high current drive capability, image quality can be improved without increasing power consumption to a large extent.

2.2 Second Configuration Example

The configuration of the common electrode voltage generation circuit 66 according to this embodiment is not limited to the configuration shown in FIG. 13.

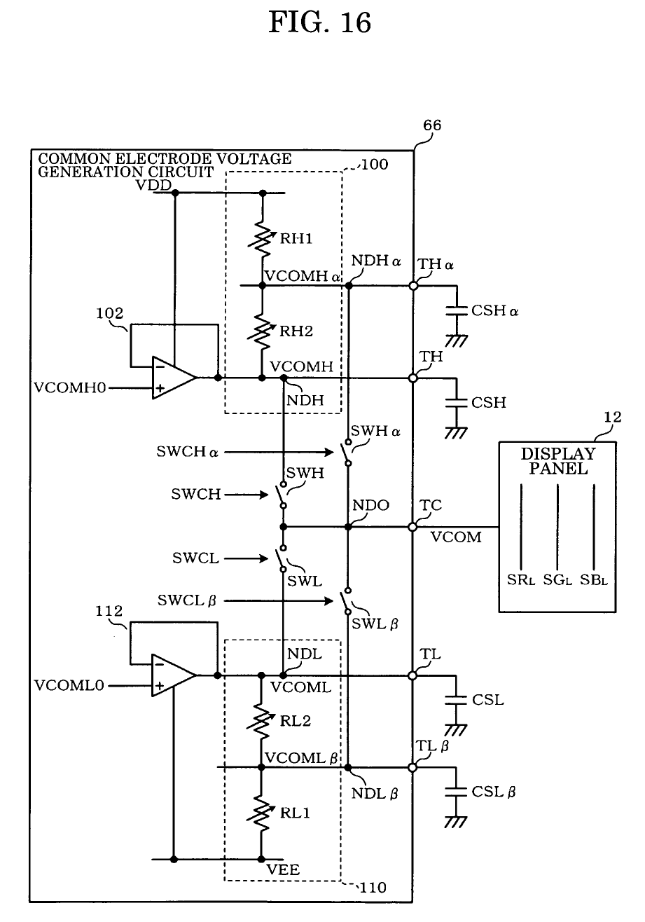

FIG. 16 is a block diagram showing a configuration example of a common electrode voltage generation circuit according to a second configuration example of this embodiment. In FIG. 16, the same sections as in FIG. 13 are indicated by the same symbols. Description of these sections is appropriately omitted.

The common electrode voltage generation circuit according to the second configuration example differs from the common electrode voltage generation circuit according to the first configuration example shown in FIG. 13 as to the configurations of the first VCOMH generation circuit 100 and the first VCOML generation circuit.

In the second configuration example, the first VCOMH generation circuit 100 outputs a voltage obtained by dividing the voltage between a given high-potential-side power supply and the output of the second VCOMH generation circuit 102 using resistors as the first high-potential-side voltage VCOMHα. The high-potential-side power supply VDD of the operational amplifier which forms the second VCOMH generation circuit 102 may be employed as the given high-potential-side power supply. Specifically, a variable resistor RH1 is provided between the high-potential-side power supply VDD of the operational amplifier which forms the second VCOMH generation circuit 102 and the output node NDHα, and a variable resistor RH2 is provided between the output node NDHα and the output node NDH of the second VCOMH generation circuit 102.

In the second configuration example, the first VCOML generation circuit 110 outputs a voltage obtained by dividing the voltage between a given low-potential-side power supply and the output of the second VCOML generation circuit 102 using resistors as the first low-potential-side voltage VCOMLβ. The low-potential-side power supply VEE of the operational amplifier which forms the second VCOML generation circuit 112 may be employed as the given low-potential-side power supply. Specifically, a variable resistor RL1 is provided between the low-potential-side power supply VEE of the operational amplifier which forms the second VCOML generation circuit 112 and the output node NDLβ, and a variable resistor RL2 is provided between the output node NDLβ and the output node NDL of the second VCOML generation circuit 112.

The second configuration example is the same as the first configuration example excluding the above points. Therefore, further description is omitted.

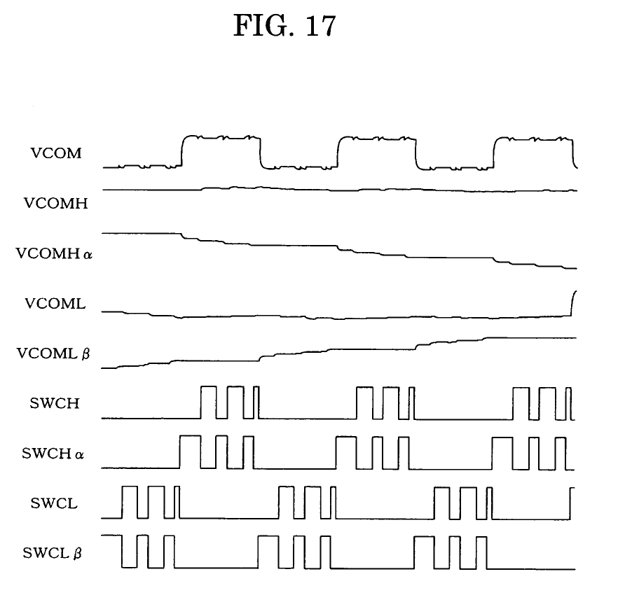

FIG. 17 is a simulation waveform diagram showing an operation example of the common electrode voltage generation circuit 66 according to the second configuration example. In FIG. 17, the amplitude of the waveform of the common electrode voltage VCOM differs from the amplitudes of the waveforms of the high-potential-side voltage VCOMH and the low-potential-side voltage VCOML so that the operation waveform can be readily understood.

In FIG. 17, the output potential of the second VCOMH generation circuit 102 and the output potential of the second VCOML generation circuit 112 change to only a small extent in the same manner as in FIG. 15. In FIG. 17, the potential of the first high-potential-side voltage VCOMHα is recovered slowly due to the variable resistors RH1 and RH2. However, the first high-potential-side voltage VCOMHα can be recovered quickly by changing the resistances of the variable resistors RH1 and RH2 or short-circuiting the first high-potential-side voltage VCOMHα and a given voltage. For example, the output node NDHα and the output node NDH may be short-circuited in a blanking period. Likewise, the potential of the first low-potential-side voltage VCOMLβ is recovered slowly due to the variable resistors RL1 and RL2. However, the first low-potential-side voltage VCOMLβ can be recovered quickly by changing the resistances of the variable resistors RL1 and RL2 or short-circuiting the first low-potential-side voltage VCOMLβ and a given voltage. For example, the output node NDLβ and the output node NDL may be short-circuited in a blanking period.

2.3 Third Configuration Example

The configuration of the common electrode voltage generation circuit 66 according to this embodiment is not limited to the configurations shown in FIGS. 13 and 16.

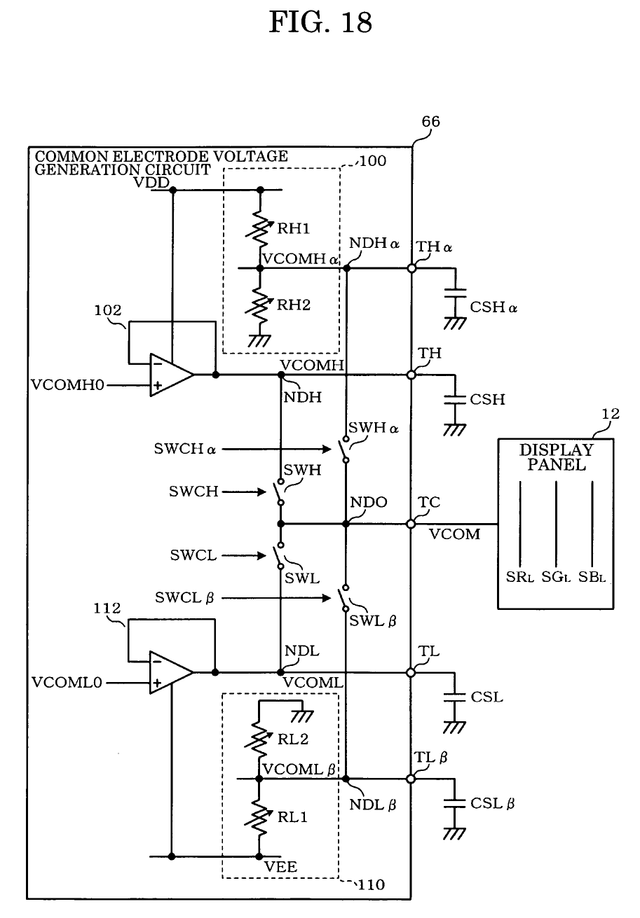

FIG. 18 is a block diagram showing a configuration example of a common electrode voltage generation circuit according to a third configuration example of this embodiment. In FIG. 18, the same sections as in FIG. 16 are indicated by the same symbols. Description of these sections is appropriately omitted.

The common electrode voltage generation circuit according to the third configuration example differs from the common electrode voltage generation circuit according to the second configuration example shown in FIG. 16 as to the configurations of the first VCOMH generation circuit 100 and the first VCOML generation circuit.

In the third configuration example, one end of the variable resistor RH2 of the first VCOMH generation circuit 100 is connected to the output node NDHα, and the system ground power supply voltage VSS is supplied to the other end of the variable resistor RH2. In the third configuration example, the system ground power supply voltage VSS is supplied to one end of the variable resistor RL2 of the first VCOML generation circuit 110, and the output node NDLβ is connected to the other end of the variable resistor RL2. Specifically, the first VCOMH generation circuit 100 outputs a voltage obtained by dividing the voltage between the high-potential-side power supply VDD and the low-potential power supply (system ground power supply voltage VSS) using resistors as the first high-potential-side voltage VCOMH. The first VCOML generation circuit 110 outputs a voltage obtained by dividing the voltage between the low-potential-side power supply VEE and the system ground power supply VSS using resistors as the first low-potential-side voltage VCOML.

The third configuration example is the same as the second configuration example excluding the above points. Therefore, further description is omitted.

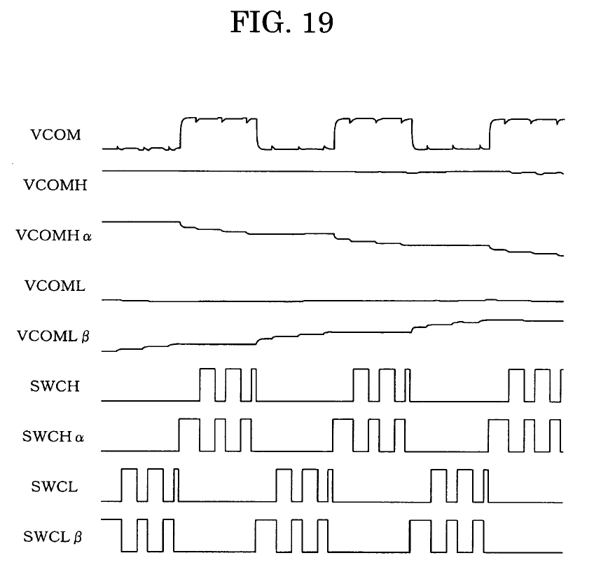

FIG. 19 is a simulation waveform diagram showing an operation example of the common electrode voltage generation circuit 66 according to the third configuration example. In FIG. 19, the amplitude of the waveform of the common electrode voltage VCOM differs from the amplitudes of the waveforms of the high-potential-side voltage VCOMH and the low-potential-side voltage VCOML so that the operation waveform can be readily understood.

In FIG. 19, the output potential of the second VCOMH generation circuit 102 and the output potential of the second VCOML generation circuit 112 change to only a small extent in the same manner as in FIG. 17. In FIG. 19, the potential of the first high-potential-side voltage VCOMHα is recovered slowly due to the variable resistors RH1 and RH2 in the same manner as in FIG. 17. However, the first high-potential-side voltage VCOMHα can be recovered quickly by changing the resistances of the variable resistors RH1 and RH2 or short-circuiting the first high-potential-side voltage VCOMHα and a given voltage. For example, the output node NDHα and the output node NDH may be short-circuited in a blanking period. Likewise, the potential of the first low-potential-side voltage VCOMLβ is recovered slowly due to the variable resistors RL1 and RL2. However, the first low-potential-side voltage VCOMLβ can be recovered quickly by changing the resistances of the variable resistors RL1 and RL2 or short-circuiting the first low-potential-side voltage VCOMLβ and a given voltage. For example, the output node NDLβ and the output node NDL may be short-circuited in a blanking period.

2.4 Fourth Configuration Example

The configuration of the common electrode voltage generation circuit 66 according to this embodiment is not limited to the configurations shown in FIGS. 13, 16, and 18.

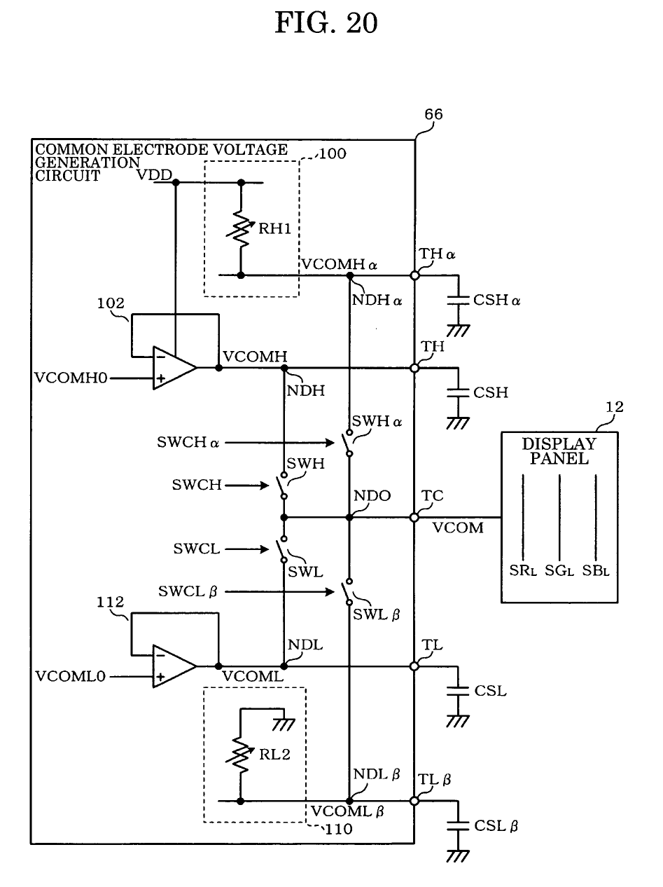

FIG. 20 is a block diagram showing a configuration example of a common electrode voltage generation circuit according to a fourth configuration example of this embodiment. In FIG. 20, the same sections as in FIG. 18 are indicated by the same symbols. Description of these sections is appropriately omitted.

The common electrode voltage generation circuit according to the fourth configuration example differs from the common electrode voltage generation circuit according to the third configuration example shown in FIG. 18 as to the configurations of the first VCOMH generation circuit 100 and the first VCOML generation circuit.

The first VCOMH generation circuit 100 according to the fourth configuration example has a configuration in which the variable resistor RH2 is omitted from the first VCOMH generation circuit according to the third configuration example. The first VCOML generation circuit 110 according to the fourth configuration example has a configuration in which the variable resistor RL1 is omitted from the first VCOML generation circuit according to the third configuration example. In the fourth configuration example, the first high-potential-side voltage VCOMHα is a voltage pulled up to a given high-potential-side power supply. The first low-potential-side voltage VCOML β is a voltage pulled down to a given low-potential-side power supply.

The fourth configuration example is the same as the third configuration example excluding the above points. Therefore, further description is omitted.

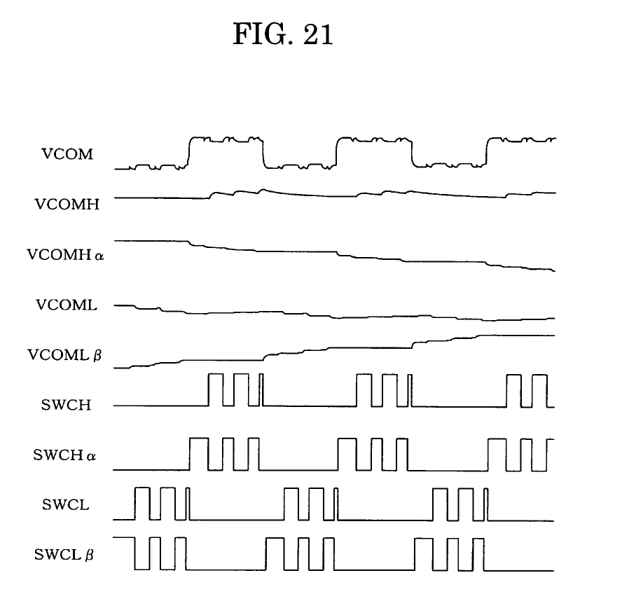

FIG. 21 is a simulation waveform diagram showing an operation example of the common electrode voltage generation circuit 66 according to the fourth configuration example. In FIG. 21, the amplitude of the waveform of the common electrode voltage VCOM differs from the amplitudes of the waveforms of the high-potential-side voltage VCOMH and the low-potential-side voltage VCOML so that the operation waveform can be readily understood.

In FIG. 21, the output potential of the second VCOMH generation circuit 102 and the output potential of the second VCOML generation circuit 112 change to only a small extent in the same manner as in FIG. 19. In FIG. 21, the potential of the first high-potential-side voltage VCOMHα is recovered slowly due to the variable resistor RH1 in the same manner as in FIG. 19. However, the first high-potential-side voltage VCOMHα can be recovered quickly by changing the resistance of the variable resistor RH1 or short-circuiting the first high-potential-side voltage VCOMHα and a given voltage. For example, the output node NDHα and the output node NDH may be short-circuited in a blanking period. Likewise, the potential of the first low-potential-side voltage VCOMLβ is recovered slowly due to the variable resistor RL2. However, the first low-potential-side voltage VCOMLβ can be recovered quickly by changing the resistance of the variable resistor RL2 or short-circuiting the first low-potential-side voltage VCOMLβ and a given voltage. For example, the output node NDLβ and the output node NDL may be short-circuited in a blanking period.

3. Other

3.1 Other Configurations of Liquid Crystal Display Device

In this embodiment, the display panel 12 separates the grayscale voltages multiplexed by time division. Note that the invention is not limited thereto.

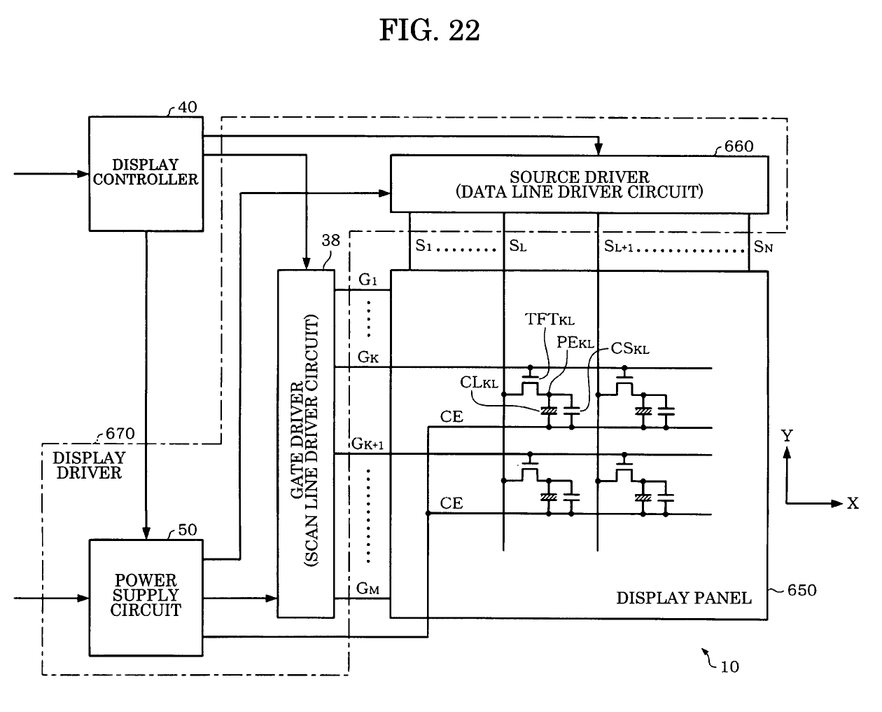

FIG. 22 schematically shows another configuration of the liquid crystal display device according to this embodiment. In FIG. 22, the same sections as in FIG. 1 are indicated by the same symbols. Description of these sections is appropriately omitted.

In FIG. 22, the liquid crystal display device 10 includes a display panel 650 instead of the display panel 12, and includes a source driver 660 instead of the source driver 20. The display panel 650 includes a plurality of gate lines, a plurality of source lines, and a plurality of pixel electrodes specified by the gate lines and the source lines. In this case, an active matrix type liquid crystal device may be formed by connecting a thin film transistor (TFT) to the source line and connecting the pixel electrode to the TFT.

Specifically, the display panel 650 is an amorphous silicon liquid crystal panel in which an amorphous silicon thin film is formed on an active matrix substrate (e.g. glass substrate). Gate lines G₁ to G_{M} (M is a natural number equal to or larger than two), arranged in a direction Y in FIG. 22 and extending in a direction X, and source lines S₁ to S_{N} (N is a natural number equal to or larger than two), arranged in the direction X and extending in the direction Y, are disposed on the active matrix substrate. A thin film transistor TFT_{KL} (switching element in a broad sense) is provided at a position corresponding to the intersection of the gate line G_{K} (1≦K≦M, K is a natural number) and the source line S₁ (1≦L≦N, L is a natural number).

A thin film transistor TFT_{KL} (switching element in a broad sense) is provided at a position corresponding to the intersection of the gate line G_{K} (1≦K≦M, K is a natural number) and the source line S_{L} (1≦L≦N, L is a natural number).

For example, a gate electrode of the thin film transistor TFT_{KL} is connected to the gate line G_{K}, a source electrode of the thin film transistor TFT_{KL} is connected to the source line S_{L}, and a drain electrode of the thin film transistor TFT_{KL} is connected to a pixel electrode PE_{KL}. A liquid crystal capacitor CL_{KL} (liquid crystal element) and an auxiliary capacitor CS_{KL} are formed between the pixel electrode PE_{KL} and a common electrode CE opposite to the pixel electrode PE_{KL} through a liquid crystal (electro-optical material in a broad sense). The liquid crystal is sealed between the active matrix substrate provided with the thin film transistor TFT_{KL}, the pixel electrode PE_{KL}, and the like and a common substrate provided with the common electrode CE. The transmissivity of the pixel changes depending on the voltage applied between the pixel electrode PE_{KL} and the common electrode CE.

The source driver 660 drives the source lines S₁ to S_{N} of the display panel 650 based on grayscale data. A gate driver 38 scans (sequentially drives) the gate lines G₁ to G_{M} of the display panel 650.

A display driver 670 may include the source driver 660, the gate driver 38, and a power supply circuit 50.

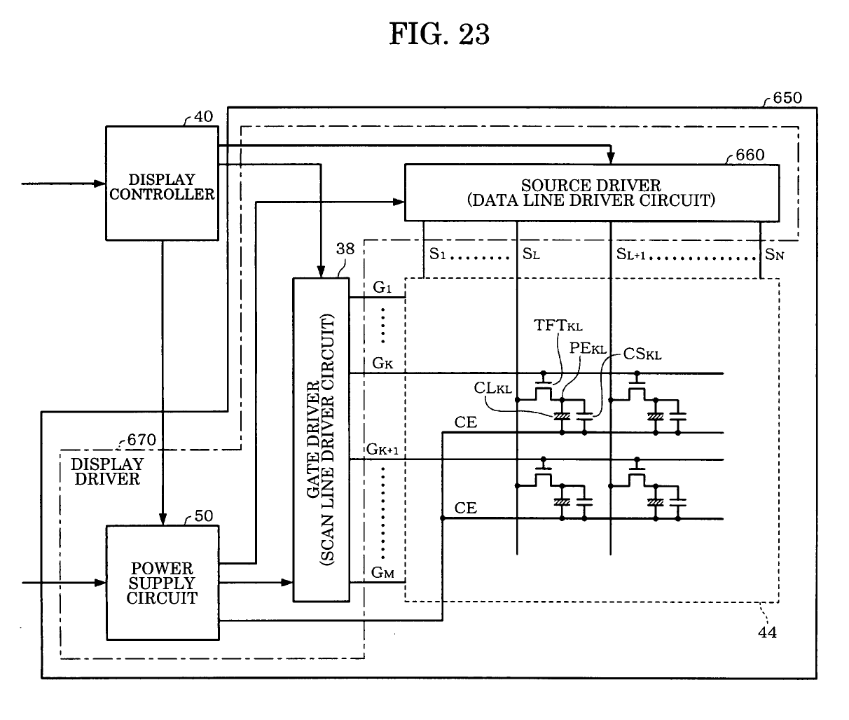

FIG. 23 is a block diagram showing another configuration example of the liquid crystal display device shown in FIG. 22. In FIG. 23, the same sections as in FIG. 22 are indicated by the same symbols. Description of these sections is appropriately omitted.

In FIG. 23, the display driver 670 which includes the source driver 660, the gate driver 38, and the power supply circuit 50 is formed on the display panel 650 (panel substrate). Specifically, the display panel 650 may be configured to include a plurality of gate lines, a plurality of source lines, a plurality of pixels (pixel electrodes), each of which is connected to the corresponding gate line and the corresponding source line, a source driver which drives the source lines, and a gate driver which scans the gate lines. A plurality of pixels are formed in a pixel formation region 44 of the display panel 650. Each pixel may include a TFT, of which the source is connected to the source line and the gate is connected to the gate line, and a pixel electrode connected to the drain of the TFT.

In FIG. 23, at least one of the gate driver 38 and the power supply circuit 50 may be omitted from the display panel 650.

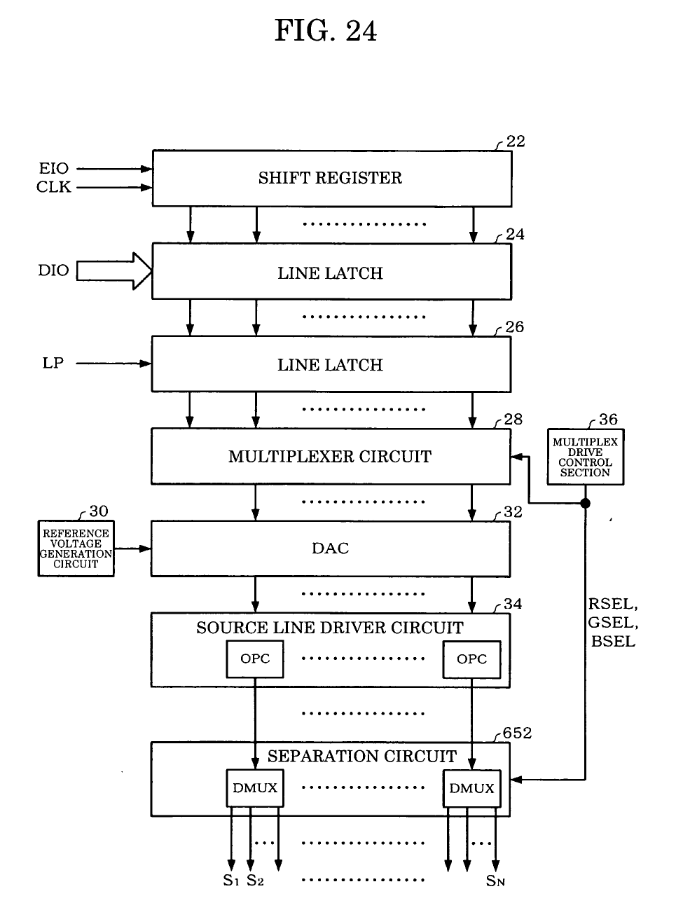

FIG. 24 is a block diagram showing a configuration example of the source driver 660 shown in FIG. 22 or 23. In FIG. 24, the same sections as in FIG. 4 are indicated by the same symbols. Description of these sections is appropriately omitted.

The source driver 660 shown in FIG. 24 differs from the source driver 20 shown in FIG. 4 in that a separation circuit 652 is provided on the output side of the source line driver circuit 34. The separation circuit 652 includes a plurality of demultiplexers which are respectively provided corresponding to the operational amplifiers of the source line driver circuit 34. Each demultiplexer of the separation circuit 652 has the same function as each demultiplexer of the display panel 12 shown in FIG. 1 or 2. Therefore, each demultiplexer of the separation circuit 652 separates the grayscale voltages multiplexed by time division which are supplied from the corresponding operational amplifier based on the multiplex control signals RSEL, GSEL, and BSEL supplied from the multiplex drive control section 36.

The effects obtained by driving the source lines using the liquid crystal display device 10 and the source driver 20 can also be achieved when driving the source lines using the liquid crystal display device 10 including the display panel 650 and the source driver 660 shown in FIGS. 22 to 24. In FIGS. 22 to 24, a less expensive amorphous silicon liquid crystal panel can be used. Moreover, the circuit scale of the source driver 660 can be significantly reduced.

3.2 Another Configuration of Source Driver

The above embodiment has been described taking a liquid crystal display device which performs multiplex drive as an example. Note that the invention may also be applied to a liquid crystal display device which performs normal drive.

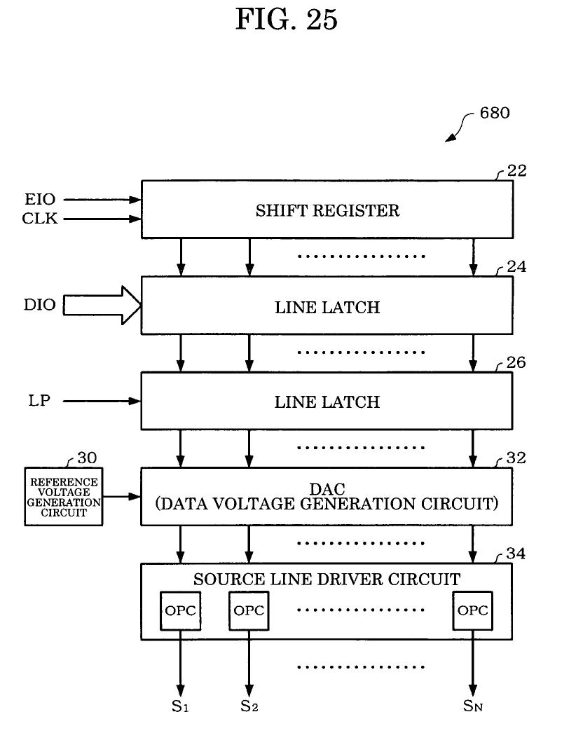

FIG. 25 is a block diagram showing another configuration example of the source driver according to this embodiment. In FIG. 25, the same sections as in FIG. 4 are indicated by the same symbols. Description of these sections is appropriately omitted.

A source driver 680 shown in FIG. 25 can drive the source lines of the display panel 650 shown in FIG. 22 or 23. The source driver 680 shown in FIG. 25 differs from the source driver 20 shown in FIG. 4 in that the multiplexer circuit 28 and the multiplex drive control section 36 are omitted.

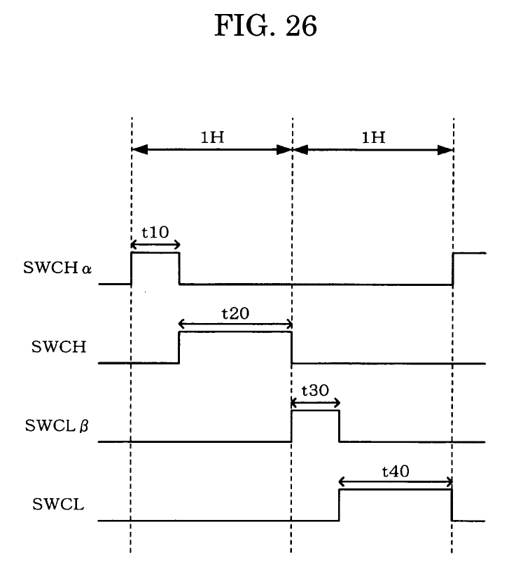

FIG. 26 is a timing diagram showing a control example of the common electrode voltage generation circuit 66 shown in FIG. 13 when the source driver 680 performs normal drive.

In this case, when supplying the high-potential-side voltage to the common electrode CE, the common electrode voltage generation circuit 66 electrically connects the output of the first VCOMH generation circuit 100 to the common electrode CE, and then electrically connects the output of the second VCOMH generation circuit 102 to the common electrode CE. Therefore, the switch control signal SWCHα becomes active and the switch control signal SWCH then becomes active within one horizontal scan period.

It is desirable that a period t10 in which the output of the first VCOMH generation circuit 100 is electrically connected to the common electrode CE be shorter than a period t20 in which the output of the second VCOMH generation circuit 102 is electrically connected to the common electrode CE. Specifically, a change in the potential level of the high-potential-side voltage of the common electrode CE can be reduced as the period t20 in which the output of the second VCOMH generation circuit 102 is electrically connected to the common electrode CE increases.

Likewise, when supplying the low-potential-side voltage to the common electrode CE, the common electrode voltage generation circuit 66 electrically connects the output of the first VCOML generation circuit 110 to the common electrode CE, and then electrically connects the output of the second VCOML generation circuit 112 to the common electrode CE. Therefore, the switch control signal SWCLβ becomes active and the switch control signal SWCL then becomes active within one horizontal scan period.

It is desirable that a period t30 in which the output of the first VCOML generation circuit 110 is electrically connected to the common electrode CE be shorter than a period t40 in which the output of the second VCOML generation circuit 112 is electrically connected to the common electrode CE. Specifically, a change in the potential level of the low-potential-side voltage of the common electrode CE can be reduced as the period t40 in which the output of the second VCOML generation circuit 112 is electrically connected to the common electrode CE increases.

According to this embodiment, even when performing normal drive, when switching the common electrode voltage VCOM from the high-potential-side voltage to the low-potential-side voltage, a charge is redistributed between the load capacitor of the common electrode CE and the first low-potential-side stabilization capacitor element CSLβ. The output of the second VCOML generation circuit 112 is then electrically connected to the common electrode CE. However, since the amount of charge redistributed between the load capacitor of the common electrode CE and the second low-potential-side stabilization capacitor element CSL is small, the output potential of the second VCOML generation circuit II 2 changes to only a small extent. Likewise, when switching the common electrode voltage VCOM from the low-potential-side voltage to the high-potential-side voltage, a charge is redistributed between the load capacitor of the common electrode CE and the first high-potential-side stabilization capacitor element CSHα. The output of the second VCOMH generation circuit 102 is then electrically connected to the common electrode CE. However, since the amount of charge redistributed between the load capacitor of the common electrode CE and the second high-potential-side stabilization capacitor element CSH is small, the output potential of the second VCOMH generation circuit 102 changes to only a small extent.

Therefore, even if the load capacitance of the common electrode increases, a change in the voltage of the common electrode can be suppressed while suppressing an increase in power consumption.

4. Electronic Instrument

An electronic instrument to which the above-described liquid crystal display device (e.g., source driver and power supply circuit) is applied is described below.

4.1 Projection-Type Display Device

A projection-type display device is one type of electronic instrument which is formed using the above-described liquid crystal display device.

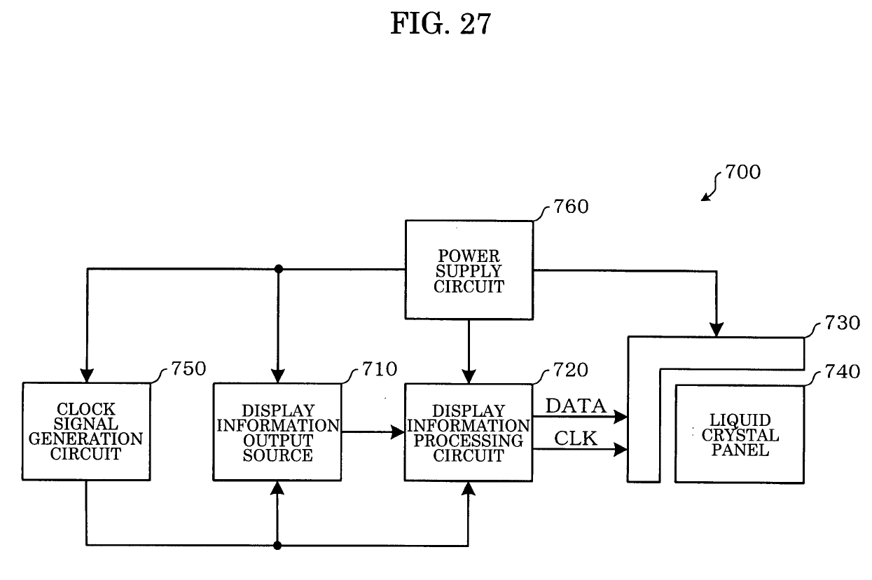

FIG. 27 is a block diagram showing a configuration example of a projection-type display device to which the liquid crystal display device according to the above embodiment is applied.

A projection-type display device 700 includes a display information output source 710, a display information processing circuit 720, a display driver circuit 730 (display driver), a liquid crystal panel 740 (display panel in a broad sense), a clock signal generation circuit 750, and a power supply circuit 760. The display information output source 710 includes a memory such as a read only memory (ROM), a random access memory (RAM), or an optical disk device, and a tuning circuit which tunes and outputs an image signal. The display information output source 710 outputs display information (e.g., an image signal in a given format) to the display information processing circuit 720 based on a clock signal from the clock signal generation circuit 750. The display information processing circuit 720 may include an amplification/polarity inversion circuit, a phase expansion circuit, a rotation circuit, a gamma correction circuit, a clamping circuit, and the like. The display driver circuit 730 includes a gate driver and a source driver. The display driver circuit 730 drives the liquid crystal panel 740. The power supply circuit 760 supplies power to each circuit.

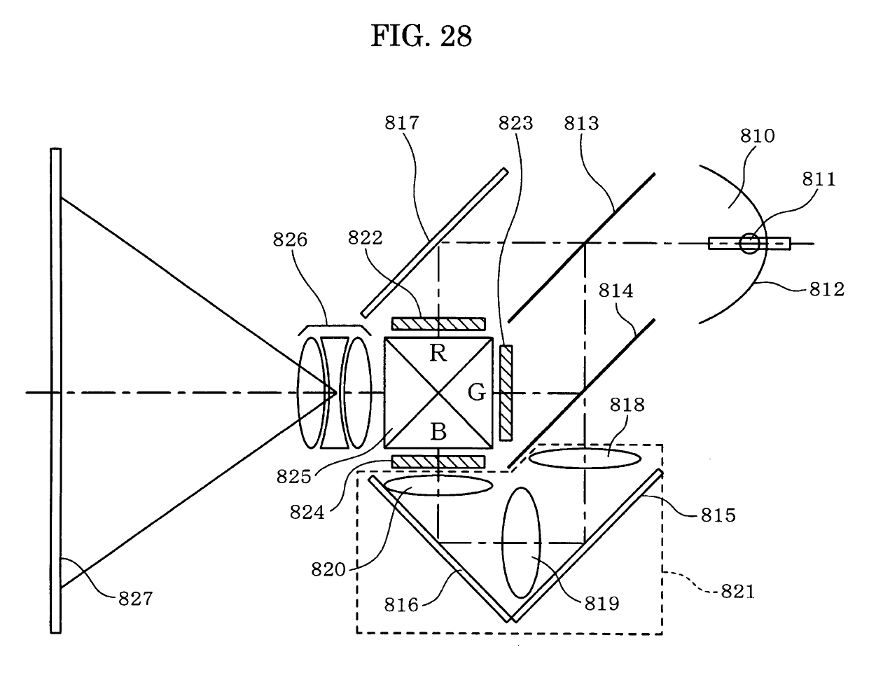

FIG. 28 is a schematic view showing the main portion of the projection-type display device.

The projection-type display device includes a light source 810, dichroic mirrors 813 and 814, reflection mirrors 815, 816, and 817, an incident lens 818, a relay lens 819, an exit lens 820, liquid crystal light modulators 822, 823, and 824, a cross dichroic prism 825, and a projection lens 826. The light source 810 includes a lamp 811 (e.g., metal halide lamp), and a reflector 812 which reflects light emitted from the lamp. The dichroic mirror 813 which reflects blue/green light allows red light contained in a beam from the light source 810 to pass through, and reflects blue light and green light. Red light which has passed through the dichroic mirror 813 is reflected by the reflection mirror 817, and enters the red light liquid crystal light modulator 822. Green light reflected by the dichroic mirror 813 is reflected by the dichroic mirror 814 which reflects green light, and enters the green light liquid crystal light modulator 823. Blue light also passes through the second dichroic mirror 814. A photo-conductive means 821 formed of a relay lens system including the incident lens 818, the relay lens 819, and the exit lens 820 is provided for blue light in order to prevent optical loss due to a long optical path. Blue light enters the blue light liquid crystal light modulator 824 through the photo-conductive means 821. The three color light rays modulated by each light modulator circuit enter the cross dichroic prism 825. Four rectangular prisms are bonded in the cross dichroic prism 825, and a dielectric multilayer film which reflects red light and a dielectric multilayer film which reflects blue light are formed on the inner side in the shape of a cross. The three color light rays are synthesized by the dielectric multilayer films so that light which expresses a color image is formed. The projection means of the projection-type display device is formed as described above. Light synthesized by the projection means is projected onto a screen 827 by a projection lens 826 (projection optical system) so that an enlarged image is displayed.

4.2 Portable Telephone

A portable telephone is another type of electronic instrument which is formed using the above-described liquid crystal display device.

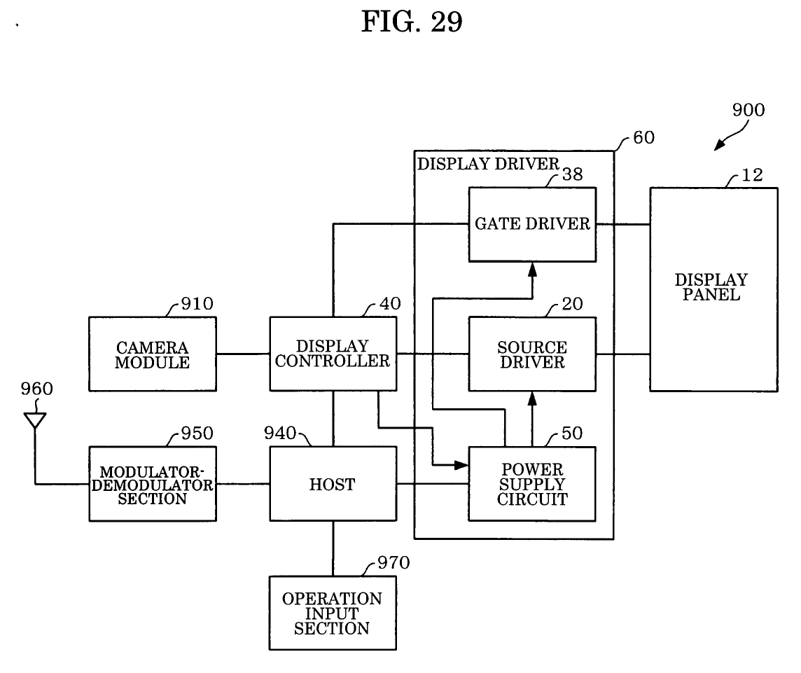

FIG. 29 is a block diagram showing a configuration example of a portable telephone to which the liquid crystal display device according to the above embodiment is applied. In FIG. 29, the same sections as in FIG. 1, 2, 22, or 23 are indicated by the same symbols. Description of these sections is appropriately omitted.

A portable telephone 900 includes a camera module 910. The camera module 910 includes a CCD camera, and supplies image data obtained by the CCD camera to a display controller 40 in a YUV format.

The portable telephone 900 includes the display panel 12 (or display panel 650; hereinafter the same). The display panel 12 is driven by the source driver 20 (or source driver 660 or 680; hereinafter the same) and the gate driver 38. The display panel 12 includes a plurality of gate lines, a plurality of source lines, and a plurality of pixels.

The display controller 40 is connected to the source driver 20 and the gate driver 38, and supplies grayscale data in an RGB format to the source driver 20.

The power supply circuit 50 is connected to the source driver 20 and the gate driver 38, and supplies drive power supply voltages to the source driver 20 and the gate driver 38. The power supply circuit 50 supplies the common electrode voltage VCOM to the common electrode of the display panel 12.

A host 940 is connected to the display controller 40. The host 940 controls the display controller 40. The host 940 demodulates grayscale data received via an antenna 960 using a modulator-demodulator section 950, and supplies the demodulated grayscale data to the display controller 40. The display controller 40 causes the source driver 20 and the gate driver 38 to display an image on the display panel 12 based on the grayscale data.

The host 940 modulates grayscale data generated by the camera module 910 using the modulator-demodulator section 950, and directs transmission of the modulated data to another communication device via the antenna 960.

The host 940 transmits and receives grayscale data, captures an image using the camera module 910, and displays an image on the display panel 12 based on operation information from an operation input section 970.

In FIG. 29, the host 940 or the display controller 40 may be referred to as a means that supplies the grayscale data.

The invention is not limited to the above embodiments. Various modifications and variations may be made within the spirit and scope of the invention. For example, the invention may be applied not only to drive the liquid crystal display panel, but also to drive an electroluminescence display device, a plasma display device, and the like. The invention may be applied to a drive method other than the above-described scan line inversion drive. The invention is not limited to the polarity inversion drive method.

Some of the requirements of any claim of the invention may be omitted from a dependent claim which depends on that claim. Some of the requirements of any independent claim of the invention may be allowed to depend on any other independent claim.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A common electrode voltage generation circuit that supplies a high-potential-side voltage or a low-potential-side voltage to a common electrode opposite to a pixel electrode through an electro-optical substance, the common electrode voltage generation circuit comprising:
a first high-potential-side voltage generation circuit that outputs a first high-potential-side voltage, an output of the first high-potential-side voltage generation circuit being connected to one end of a first high-potential-side stabilization capacitor element; and
a second high-potential-side voltage generation circuit that outputs a second high-potential-side voltage, an output of the second high-potential-side voltage generation circuit being connected to one end of a second high-potential-side stabilization capacitor element,
when supplying the high-potential-side voltage to the common electrode, the common electrode voltage generation circuit electrically connecting the output of the first high-potential-side voltage generation circuit to the common electrode, and then electrically connecting the output of the second high-potential-side voltage generation circuit to the common electrode.

2. The common electrode voltage generation circuit as defined in claim 1,
the first high-potential-side voltage generation circuit outputting a divided voltage as the first high-potential-side voltage, the divided voltage being obtained by dividing a voltage between a given high-potential-side power supply and the output of the second high-potential-side voltage generation circuit using resistors.

3. The common electrode voltage generation circuit as defined in claim 1,
the first high-potential-side voltage generation circuit outputting a divided voltage as the first high-potential-side voltage, the divided voltage being obtained by dividing a voltage between a given high-potential-side power supply and a given low-potential-side power supply using resistors.

4. The common electrode voltage generation circuit as defined in claim 1,
the first high-potential-side voltage generation circuit outputting a voltage pulled up to a given high-potential-side power supply as the first high-potential-side voltage.

5. The common electrode voltage generation circuit as defined in claim 2,
the second high-potential-side voltage generation circuit including an operational amplifier, a given reference high-potential-side voltage being input to the operational amplifier; and
the given high-potential-side power supply being a high-potential-side power supply of the operational amplifier.

6. The common electrode voltage generation circuit as defined in claim 1,
the first high-potential-side voltage being higher in potential than the second high-potential-side voltage.

7. The common electrode voltage generation circuit as defined in claim 1,
a period when the output of the first high-potential-side voltage generation circuit is electrically connected to the common electrode being shorter than a period when the output of the second high-potential-side voltage generation circuit is electrically connected to the common electrode.

8. The common electrode voltage generation circuit as defined in claim 1,
when performing multiplex drive that writes a corresponding grayscale voltage among a plurality of grayscale voltages into the pixel electrode in each of a plurality of periods, the corresponding grayscale voltage corresponding to one period among the plurality of periods, the plurality of periods being specified by dividing one horizontal scan period, the common electrode voltage generation circuit electrically connecting the output of the first high-potential-side voltage generation circuit to the common electrode and then electrically connecting the output of the second high-potential-side voltage generation circuit to the common electrode in each of the plurality of periods when supplying the high-potential-side voltage to the common electrode.

9. The common electrode voltage generation circuit as defined in claim 1, further comprising:
a first high-potential-side terminal that is connected to the one end of the first high-potential-side stabilization capacitor element; and
a second high-potential-side terminal that is connected to the one end of the second high-potential-side stabilization capacitor element.

10. A common electrode voltage generation circuit that supplies a high-potential-side voltage or a low-potential-side voltage to a common electrode opposite to a pixel electrode through an electro-optical substance, the common electrode voltage generation circuit comprising:
a first low-potential-side voltage generation circuit that outputs a first low-potential-side voltage, an output of the first low-potential-side voltage generation circuit being connected to one end of a first low-potential-side stabilization capacitor element; and
a second low-potential-side voltage generation circuit that outputs a second low-potential-side voltage, an output of the second low-potential-side voltage generation circuit being connected to one end of a second low-potential-side stabilization capacitor element,
when supplying the low-potential-side voltage to the common electrode, the common electrode voltage generation circuit electrically connecting the output of the first low-potential-side voltage generation circuit to the common electrode, and then electrically connecting the output of the second low-potential-side voltage generation circuit to the common electrode.

11. The common electrode voltage generation circuit as defined in claim 10,
the first low-potential-side voltage generation circuit outputting a divided voltage as the first low-potential-side voltage, the divided voltage being obtained by dividing a voltage between a given low-potential-side power supply and the output of the second low-potential-side voltage generation circuit using resistors.

12. The common electrode voltage generation circuit as defined in claim 10,
the first low-potential-side voltage generation circuit outputting a divided voltage as the first low-potential-side voltage, the divided voltage being obtained by dividing a voltage between a given low-potential-side power supply and a ground power supply using resistors.

13. The common electrode voltage generation circuit as defined in claim 10,
the first low-potential-side voltage generation circuit outputting a voltage pulled down to a given low-potential-side power supply as the first low-potential-side voltage.

14. The common electrode voltage generation circuit as defined in claim 11,
the second low-potential-side voltage generation circuit including an operational amplifier, a given reference low-potential-side voltage being input to the operational amplifier; and
the given low-potential-side power supply being a low-potential-side power supply of the operational amplifier.

15. The common electrode voltage generation circuit as defined in claim 10,
the first low-potential-side voltage being lower in potential than the second low-potential-side voltage.

16. The common electrode voltage generation circuit as defined in claim 10,
a period when the output of the first low-potential-side voltage generation circuit is electrically connected to the common electrode being shorter than a period when the output of the second low-potential-side voltage generation circuit is electrically connected to the common electrode.

17. The common electrode voltage generation circuit as defined in claim 10,
when performing multiplex drive that writes a corresponding grayscale voltage among a plurality of grayscale voltages into the pixel electrode in each of a plurality of periods, the corresponding grayscale voltage corresponding to one period among the plurality of periods, the plurality of periods being specified by dividing one horizontal scan period, the common electrode voltage generation circuit electrically connecting the output of the first low-potential-side voltage generation circuit to the common electrode and then electrically connecting the output of the second low-potential-side voltage generation circuit to the common electrode in each of the plurality of periods when supplying the low-potential-side voltage to the common electrode.

18. The common electrode voltage generation circuit as defined in claim 10, further comprising:
a first low-potential-side terminal that is connected to the one end of the first low-potential-side stabilization capacitor element; and
a second low-potential-side terminal that is connected to the one end of the second low-potential-side stabilization capacitor element.

19. A display driver that drives a source line of an electro-optical device, the display driver comprising:
a source driver that drives the source line; and
the common electrode voltage generation circuit as defined in claim 1 that supplies the common electrode voltage to a common electrode of the electro-optical device, the common electrode being opposite to a pixel electrode through an electro-optical substance.

20. An electronic instrument comprising the common electrode voltage generation circuit as defined in claim 1.
